(19) United States
(12) Patent Application Publication
(10) Pub. No.: US 2025/0199423 A1
(43) Pub. Date: Jun. 19, 2025

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Fuyuki KANO, Kanagawa (JP); Yoichi KIGOSHI, Kanagawa (JP); Keisuke KUSANO, Kanagawa (JP); Yuki OYAMADA, Kanagawa (JP); Masahiro IWASAKI, Kanagawa (JP); Kohei TAKAOKA, Kanagawa (JP); Kenta IDE, Kanagawa (JP)

(73) Assignee: FUJIFILM Business Innovation Corp., Tokyo (JP)

(21) Appl. No.: 18/741,543

(22) Filed: Jun. 12, 2024

(30) Foreign Application Priority Data
Dec. 18, 2023 (JP) 2023-213270

(51) Int. Cl. G03G 5/05; G03G 5/047; G03G 5/06; G03G 21/18

(52) U.S. Cl. CPC G03G 5/0546; G03G 5/047; G03G 5/06147; G03G 21/1814

(57) ABSTRACT

An electrophotographic photoreceptor includes: a conductive substrate; and a photosensitive layer that is disposed on the conductive substrate and has a charge generation layer and a charge transport layer. The charge transport layer contains a charge-transporting material and a polyarylate resin having a dicarboxylic acid unit represented by formula (A) and a diol unit represented by formula (B). The mass ratio of the charge-transporting material in the charge transport layer is 56 mass % or more and 70 mass % or less.

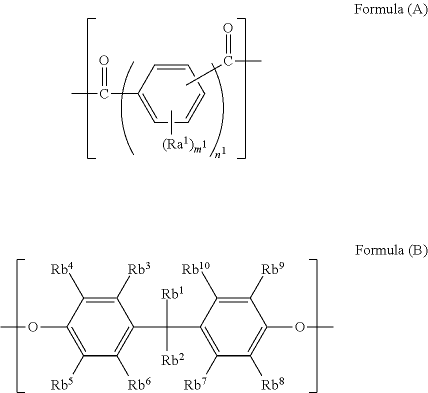

In formula (A), n¹ is 1, 2, or 3, n¹ m¹'s are each independently 0, 1, 2, 3, or 4, and m¹ Ra¹'s are each independently a C1-C10 alkyl group, a C6-C12 aryl group, or a C1-C6 alkoxy group. In formula (B), Rb¹ and Rb² are each independently a hydrogen atom, a C1-C20 alkyl group, a C6-C12 aryl group, or a C7-C20 aralkyl group, Rb³, Rb⁴, Rb⁵, Rb⁶, Rb⁷, Rb⁸, Rb⁹, and Rb¹⁰ are each independently a hydrogen atom, a C1-C10 alkyl group, a C6-C12 aryl group, a C7-C20 aralkyl group, or a C1-C6 alkoxy group, and Rb¹ and Rb² taken together optionally form a cyclic alkyl group.

### CROSS-REFERENCE TO RELATED APPLICATIONS

This application is based on and claims priority under 35 USC 119 from Japanese Patent Application No. 2023-213270 filed Dec. 18, 2023.

### BACKGROUND

### (i) Technical Field

The present disclosure relates to an electrophotographic photoreceptor, a process cartridge, and an image forming apparatus.

### (ii) Related Art

Japanese Unexamined Patent Application Publication No. 6-332206 discloses an electrophotographic photoreceptor including a charge generation layer and a charge transport layer stacked in this order on a conductive support, wherein the charge transport layer contains a charge transport substance represented by a predetermined chemical formula, a polycarbonate resin, and a biphenyl derivative represented by a predetermined chemical formula.

International Publication No. WO 2017/073176 discloses an electrophotographic photoreceptor including a conductive substrate and a photosensitive layer, wherein the photosensitive layer contains a charge generating agent, a charge-transporting agent, and a polyarylate resin having a repeating unit represented by a predetermined chemical formula.

Japanese Unexamined Patent Application Publication No. 2023-47285 discloses an electrophotographic photoreceptor including a conductive substrate and a multilayer-type photosensitive layer that is disposed on the conductive substrate and that has a charge generation layer and a charge transport layer, wherein the charge transport layer contains a polyarylate resin and a charge-transporting material, and the ratio M1/M2 of the mass M1 of the charge-transporting material in the charge transport layer to the mass M2 of the charge transport layer is 0.28 or more and 0.55 or less.

### SUMMARY

Aspects of non-limiting embodiments of the present disclosure relate to an electrophotographic photoreceptor having better electrical properties and higher wear resistance than an electrophotographic photoreceptor in which the mass ratio of the charge- transporting material in the charge transport layer is less than 56 mass %, or more than 70 mass %.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above object include the following aspects. The formulas representing compounds are the same as the formulas with the same numbers described below.

According to an aspect of the present disclosure, there is provided an electrophotographic photoreceptor including: a conductive substrate; and a photosensitive layer that is disposed on the conductive substrate and has a charge generation layer and a charge transport layer, wherein the charge transport layer contains a charge-transporting material and a polyarylate resin having a dicarboxylic acid unit represented by formula (A) and a diol unit represented by formula (B), and a mass ratio of the charge-transporting material in the charge transport layer is 56 mass % or more and 70 mass % or less,

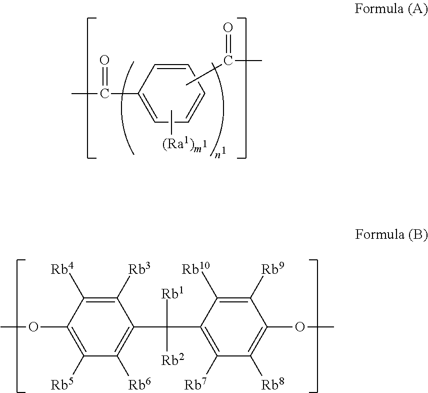

in formula (A), n¹ is 1, 2, or 3, n¹ m¹'s are each independently 0, 1, 2, 3, or 4, and m¹ Ra¹'s are each independently a C1-C10 alkyl group, a C6-C12 aryl group, or a C1-C6 alkoxy group, and
in formula (B), Rb¹ and Rb² are each independently a hydrogen atom, a C1-C20 alkyl group, a C6-C12 aryl group, or a C7-C20 aralkyl group, Rb³, Rb⁴, Rb⁵, Rb⁶, Rb⁷, Rb⁸, Rb⁹, and Rb¹⁰ are each independently a hydrogen atom, a C1-C10 alkyl group, a C6-C12 aryl group, a C7-C20 aralkyl group, or a C1-C6 alkoxy group, and Rb¹ and Rb² taken together optionally form a cyclic alkyl group.

### BRIEF DESCRIPTION OF THE DRAWINGS

Exemplary embodiments of the present disclosure will be described in detail based on the following figures, wherein:

FIG. 1 is a partial cross-sectional view of an example of the layer structure of an electrophotographic photoreceptor according to an exemplary embodiment;

FIG. 2 is a schematic structural view of one example of an image forming apparatus according to an exemplary embodiment; and

FIG. 3 is a schematic structural view of another example of the image forming apparatus according to the exemplary embodiment.

### DETAILED DESCRIPTION

Exemplary embodiments of the present disclosure will be described below. The following description and Examples are for illustrating the exemplary embodiments, and are not intended to limit the scope of the exemplary embodiments.

The phase “A and/or B” in the present disclosure has the same meaning as the phrase “at least one of A and B.” In other words, the phrase “A and/or B” means only A, only B, or a combination of A and B.

A numerical range expressed by using “to” in the present disclosure indicates a range including the values before and after “to” as the minimum value and the maximum value.

With regard to numerical ranges described stepwise in the present disclosure, the upper limit or the lower limit of one numerical range may be replaced by the upper limit or the lower limit of other numerical ranges described stepwise. The upper limit or lower limit of any numerical range described in the present disclosure may be replaced by a value described in Examples.

In the present disclosure, the term “step” includes not only an independent step but also a step that cannot be clearly distinguished from other steps but may accomplish the purpose of the step.

In the description of exemplary embodiments with reference to the drawings in the present disclosure, the structures according to the exemplary embodiments are not limited to the structures illustrated in the drawings. The sizes of members in each figure are schematic, and the relative relationship between the sizes of the members is not limited to what is illustrated.

In the present disclosure, each component may include two or more corresponding substances. In the present disclosure, the amount of each component in a composition refers to, when there are two or more substances corresponding to each component in the composition, the total amount of the substances present in the composition, unless otherwise specified.

In the present disclosure, each component may include two or more types of particles corresponding to each component. The particle size of each component refers to, when there are two or more types of particles corresponding to each component in the composition, the particle size of a mixture of two or more types of particles present in the composition, unless otherwise specified.

To express compounds by structural formulas in the present disclosure, compounds may be represented by structural formulas without symbols (C and H) representing carbon and hydrogen atoms in hydrocarbon groups and/or hydrocarbon chains.

In the present disclosure, alkyl groups and alkylene groups include linear, branched, and cyclic groups, unless otherwise specified.

In the present disclosure, hydrogen atoms in organic groups, aromatic rings, linking groups, alkyl groups, alkylene groups, aryl groups, aralkyl groups, alkoxy groups, aryloxy groups, and other groups may be substituted by halogen atoms.

In the present disclosure, the expression “(meth)acrylic” includes both acrylic and methacrylic, and the expression “(meth)acrylate” includes both acrylate and methacrylate.

In the present disclosure, the “structural unit” of a copolymer or resin has the same meaning as a monomer unit.

In the present disclosure, the “axial direction” of an electrophotographic photoreceptor means the direction in which the rotation shaft of the electrophotographic photoreceptor extends, and the “circumferential direction” of the electrophotographic photoreceptor means the rotation direction of the electrophotographic photoreceptor.

### Electrophotographic Photoreceptor

An electrophotographic photoreceptor (hereinafter also referred to as “photoreceptor”) according to an exemplary embodiment includes a conductive substrate and a photosensitive layer disposed on the conductive substrate.

The photosensitive layer of the photoreceptor according to the exemplary embodiment is a multilayer-type photosensitive layer (so-called layered photosensitive layer) having a charge generation layer and a charge transport layer.

The photoreceptor according to the exemplary embodiment may further include a layer (e.g., undercoat layer, intermediate layer) other than the photosensitive layer.

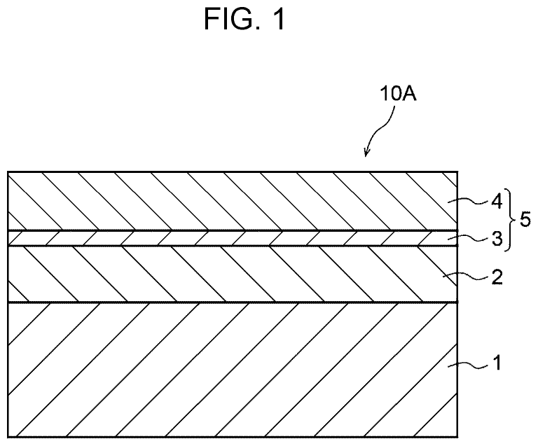

FIG. 1 is a partial cross-sectional view schematically illustrating an example of the layer structure of the photoreceptor according to the exemplary embodiment. A photoreceptor 10A illustrated in FIG. 1 includes an undercoat layer 2, a charge generation layer 3, and a charge transport layer 4, which are stacked in this order on a conductive substrate 1. The charge generation layer 3 and the charge transport layer 4 constitute a photosensitive layer 5. The photoreceptor 10A may have an intermediate layer (not shown) between the undercoat layer 2 and the charge generation layer 3.

In the photoreceptor according to the exemplary embodiment, the charge transport layer contains a charge-transporting material and a polyarylate resin having a dicarboxylic acid unit represented by formula (A) and a diol unit represented by formula (B), and the mass ratio of the charge-transporting material in the charge transport layer is 56 mass % or more and 70 mass % or less.

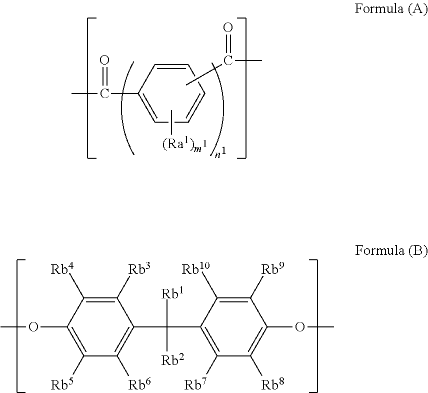

In formula (A), n¹ is 1, 2, or 3, n¹ m¹'s are each independently 0, 1, 2, 3, or 4, and m¹ Ra¹'s are each independently a C1-C10 alkyl group, a C6-C12 aryl group, or a C1-C6 alkoxy group.

In formula (B), Rb¹ and Rb² are each independently a hydrogen atom, a C1-C20 alkyl group, a C6-C12 aryl group, or a C7-C20 aralkyl group, Rb³, Rb⁴, Rb⁵, Rb⁶, Rb⁷, Rb⁸, Rb⁹, and Rb¹⁰ are each independently a hydrogen atom, a C1-C10 alkyl group, a C6-C12 aryl group, a C7-C20 aralkyl group, or a C1-C6 alkoxy group, and Rb¹ and Rb² taken together optionally form a cyclic alkyl group.

In the present disclosure, the dicarboxylic acid unit represented by formula (A) is referred to as a “dicarboxylic acid unit (A)”, the diol unit represented by formula (B) as a “diol unit (B)”, and a polyarylate resin having the dicarboxylic acid unit represented by formula (A) and the diol unit represented by formula (B) as a “polyarylate resin (1).”

When the mass ratio of the charge-transporting material in the charge transport layer is 56 mass % or more, the photoreceptor according to the exemplary embodiment has better electrical properties, that is, the photoreceptor is unlikely to increase in residual potential. The photoreceptor according to the exemplary embodiment may form images at a relatively high process speed.

When the mass ratio of the charge-transporting material in the charge transport layer is 70 mass % or less, and the charge transport layer contains the polyarylate resin (1), the photoreceptor according to the exemplary embodiment has higher wear resistance. In the polyarylate resin (1), resin molecules are bonded to each other through intermolecular forces due to stacking of aromatic rings to improve the wear resistance of the charge transport layer.

In the photoreceptor according to the exemplary embodiment, the mass ratio of the charge-transporting material in the charge transport layer is 56 mass % or more and 70 mass % or less, preferably 58 mass % or more and 68 mass % or less, more preferably 60 mass % or more and 65 mass % or less, from the viewpoint of the balance between electrical properties and wear resistance.

The mass of the charge-transporting material in the charge transport layer and the mass of the charge transport layer are measured by the following method.

The photoreceptor is dipped in various solvents (may be mixed solvents) to understand solvents that dissolve the charge transport layer. The photoreceptor is dipped in a solvent that dissolves the charge transport layer such that the charge transport layer is extracted in the solvent. The solvent in which the charge transport layer has been extracted is concentrated and vacuum-dried, and the residue is then weighed to obtain the mass of the charge transport layer.

Separately, the solvent in which the charge transport layer has been extracted is added dropwise to a poor solvent (e.g., a non-polar solvent, such as hexane or toluene, a lower alcohol, such as methanol and isopropanol. The poor solvent may be a mixed solvent.) for the polyarylate resin (1) to reprecipitate the resin. The remaining solution after reprecipitation is concentrated, and the materials are isolated by preparative thin layer chromatography to quantify the yield of each material. The charge-transporting materials are specified from the isolated materials by nuclear magnetic resonance (NMR) spectroscopy, and the yields of the charge-transporting materials are summed.

In the photoreceptor according to the exemplary embodiment, the mass ratio of the polyarylate resin (1) in the charge transport layer is 30 mass % or more and 44 mass % or less, preferably 32 mass % or more and 42 mass % or less, more preferably 35 mass % or more and 40 mass % or less, from the viewpoint of the balance between electrical properties and wear resistance.

When the mass ratio of the charge-transporting material in the charge transport layer is 56 mass % or more, the photoreceptor according to the exemplary embodiment is unlikely to increase in residual potential even when rotating at a relatively high speed. Therefore, the photoreceptor according to the exemplary embodiment may have a relatively small diameter.

The photoreceptor according to the exemplary embodiment may have a diameter of 30 mm or less, or may have a diameter of 25 mm or less. The photoreceptor according to the exemplary embodiment has a diameter of, for example, 20 mm or more.

The photoreceptor according to the exemplary embodiment may be tubular or cylindrical.

The polyarylate resin (1) and each layer of the photoreceptor will be described below in detail.

### Polyarylate Resin (1)

The polyarylate resin (1) has at least a dicarboxylic acid unit (A) and a diol unit (B). The polyarylate resin (1) may include another dicarboxylic acid unit other than the dicarboxylic acid unit (A). The polyarylate resin (1) may include another diol unit other than the diol unit (B).

The dicarboxylic acid unit (A) is a structural unit represented by formula (A).

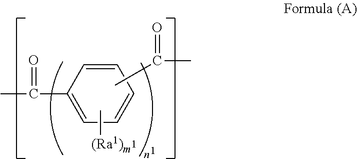

In formula (A), n¹ is 1, 2, or 3, n¹ m¹'s are each independently 0, 1, 2, 3, or 4, and m¹ Ra¹'s are each independently a C1-C10 alkyl group, a C6-C12 aryl group, or a C1-C6 alkoxy group.

In formula (A), n¹ is 1, 2, or 3, preferably 2.

When n¹ is 2, two benzene rings in formula (A) may be the same or different benzene rings in terms of m¹ and Ra¹.

When n¹ is 3, three benzene rings in formula (A) may be the same or different benzene rings in terms of m¹ and Ra¹.

When n¹ is 2 or 3 in formula (A), the benzene rings may be linked to each other at ortho, meta, or para positions, preferably at meta or para positions.

In formula (A), m¹ is 0, 1, 2, 3, or 4, preferably 0, 1, or 2, more preferably 0 or 1, still more preferably 0.

When m¹ is 2, two Ra¹'s bonded to the same benzene ring may be the same or different groups.

When m¹ is 3, three Ra¹'s bonded to the same benzene ring may be the same or different groups.

When m¹ is 4, four Ra¹'s bonded to the same benzene ring may be the same or different groups.

In formula (A), the C1-C10 alkyl group may be linear, branched, or cyclic. The number of carbon atoms in the alkyl group is preferably 1 or more and 6 or less, more preferably 1 or more and 4 or less, still more preferably 1 or 2.

In formula (A), the C6-C12 aryl group may be monocyclic or polycyclic. The number of carbon atoms in the aryl group is preferably 6 or more and 10 or less, more preferably 6 or more and 9 or less.

In formula (A), the alkyl group in the C1-C6 alkoxy group may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C10 linear alkyl group in formula (A) include methyl, ethyl, n-propyl, n-butyl, n-pentyl, n-hexyl, n-heptyl, n-octyl, n-nonyl, and n-decyl groups.

Examples of the C3-C10 branched alkyl group include isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, and tert-decyl groups.

Examples of the C3-C10 cyclic alkyl group include cyclopropyl, cyclobutyl, cyclopentyl, cyclohexyl, cycloheptyl, cyclooctyl, cyclononyl, and cyclodecyl groups, and polycyclic (e.g., bicyclic, tricyclic, spirocyclic) alkyl groups where these monocyclic alkyl groups are linked to each other.

Examples of the C6-C12 aryl group in formula (A) include phenyl, biphenyl, 1-naphthyl, and 2-naphthyl groups.

Examples of the C1-C6 linear alkoxy group in formula (A) include methoxy, ethoxy, n-propoxy, n-butoxy, n-pentyloxy, and n-hexyloxy groups.

Examples of the C3-C6 branched alkoxy group in formula (A) include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group in formula (A) include cyclopropoxy, cyclobutoxy, cyclopentyloxy, and cyclohexyloxy groups.

When m¹ is 1, 2, 3, or 4 in formula (A), Ra¹ is preferably a C1-C6 linear alkyl group or a C3-C6 branched alkyl group, preferably a C1-C4 linear alkyl group or a C3-C4 branched alkyl group, more preferably a methyl group or an ethyl group.

The dicarboxylic acid units (A-1) to (A-13) are shown below as specific examples of the dicarboxylic acid unit (A). The dicarboxylic acid unit (A) is not limited to these.

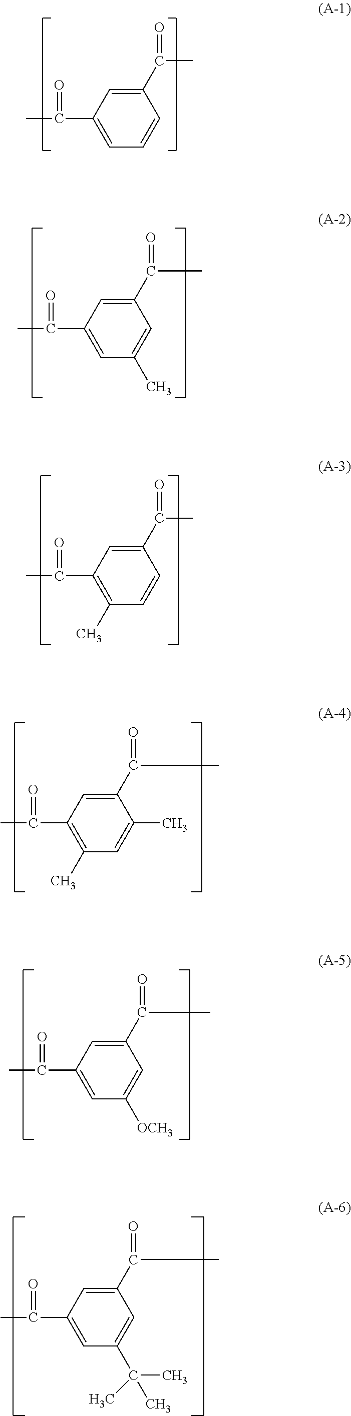

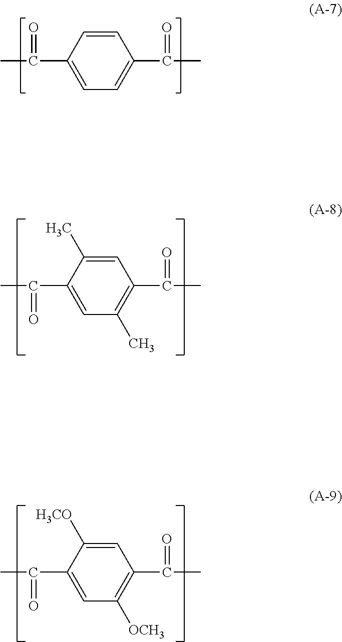

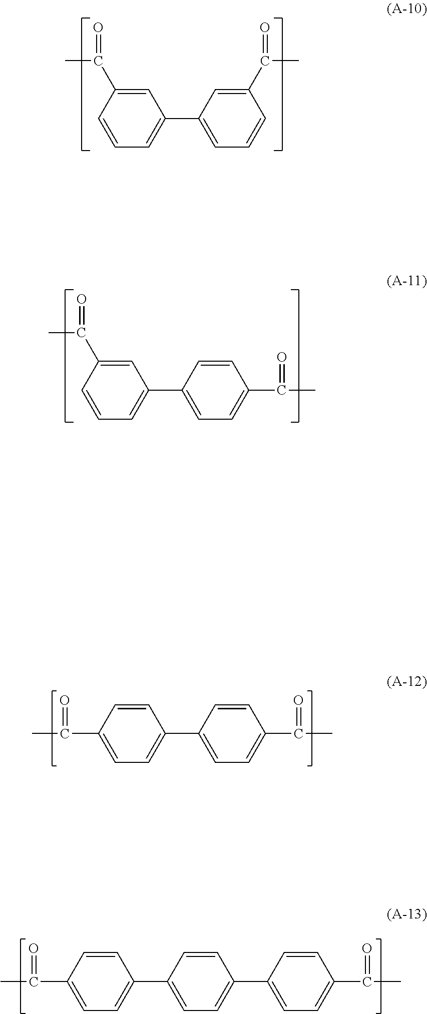

The dicarboxylic acid units (A-1), (A-7), and (A-12) in the specific examples are preferred as the dicarboxylic acid unit (A), and the dicarboxylic acid unit (A-12) is most preferred.

The polyarylate resin (1) may include one type, or two or more types of dicarboxylic acid units (A).

The diol unit (B) is a structural unit represented by formula (B).

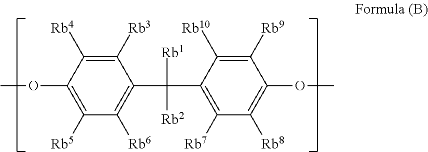

In formula (B), Rb¹ and Rb² are each independently a hydrogen atom, a C1-C20 alkyl group, a C6-C12 aryl group, or a C7-C20 aralkyl group, Rb³, Rb⁴, Rb⁵, Rb⁶, Rb⁷, Rb⁸, Rb⁹, and Rb¹⁰ are each independently a hydrogen atom, a C1-C10 alkyl group, a C6-C12 aryl group, a C7-C20 aralkyl group, or a C1-C6 alkoxy group, and Rb¹ and Rb² taken together optionally form a cyclic alkyl group.

In formula (B), the C1-C20 alkyl group represented by Rb¹ and Rb² may be linear, branched, or cyclic. The number of carbon atoms in the alkyl group is preferably 1 or more and 15 or less, more preferably 1 or more and 12 or less, still more preferably 1 or more and 10 or less.

In formula (B), the C6-C12 aryl group represented by Rb¹ and Rb² may be monocyclic or polycyclic. The number of carbon atoms in the aryl group is preferably 6 or more and 10 or less, more preferably 6 or more and 9 or less.

In formula (B), the aryl group in the C7-C20 aralkyl group represented by Rb¹ and Rb² may be monocyclic or polycyclic, and the alkyl group in the C7-C20 aralkyl group may be linear, branched, or cyclic. The number of carbon atoms in the aryl group is preferably 6 or more and 10 or less, more preferably 6 or more and 9 or less. The number of carbon atoms in the alkyl group is preferably 1 or more and 6 or less, more preferably 1 or more and 5 or less, still more preferably 1 or more and 4 or less.

In formula (B), the number of carbon atoms in the cyclic alkyl group that Rb¹ and Rb² taken together optionally form is preferably 5 or more and 15 or less, more preferably 6 or more and 12 or less.

In formula (B), the C1-C10 alkyl group represented by Rb³, Rb⁴, Rb⁵, Rb⁶, Rb⁷, Rb⁸, Rb⁹, and Rb¹⁰ may be linear, branched, or cyclic. The number of carbon atoms in the alkyl group is preferably 1 or more and 6 or less, more preferably 1 or more and 4 or less, still more preferably 1 or 2.

In formula (B), the C6-C12 aryl group represented by Rb³, Rb⁴, Rb⁵, Rb⁶, Rb⁷, Rb⁸, Rb⁹, and Rb¹⁰ may be monocyclic or polycyclic. The number of carbon atoms in the aryl group is preferably 6 or more and 10 or less, more preferably 6 or more and 9 or less.

In formula (B), the aryl group in the C7-C20 aralkyl group represented by Rb³, Rb⁴, Rb⁵, Rb⁶, Rb⁷, Rb⁸, Rb⁹, and Rb¹⁰ may be monocyclic or polycyclic, and the alkyl group in the C7-C20 aralkyl group may be linear, branched, or cyclic. The number of carbon atoms in the aryl group is preferably 6 or more and 10 or less, more preferably 6 or more and 9 or less. The number of carbon atoms in the alkyl group is preferably 1 or more and 6 or less, more preferably 1 or more and 5 or less, still more preferably 1 or more and 4 or less.

In formula (B), the alkyl group in the C1-C6 alkoxy group represented by Rb³, Rb⁴, Rb⁵, Rb⁶, Rb⁷, Rb⁸, Rb⁹, and Rb¹⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of C1-C20 linear alkyl groups in formula (B) include methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-heptadecyl, n-octadecyl, n-nonadecyl, and n-icosyl groups.

Examples of C3-C20 branched alkyl groups include isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, tert-decyl, isododecyl, sec-dodecyl, tert-dodecyl, tert-tetradecyl, and tert-pentadecyl groups.

Examples of C3-C20 cyclic alkyl groups include cyclopropyl, cyclobutyl, cyclopentyl, cyclohexyl, cycloheptyl, cyclooctyl, cyclononyl, and cyclodecyl groups, and polycyclic (e.g., bicyclic, tricyclic, spirocyclic) alkyl groups where these monocyclic alkyl groups are linked to each other.

Examples of the C6-C12 aryl group in formula (B) include phenyl, biphenyl, 1-naphthyl, and 2-naphthyl groups.

Examples of the C7-C20 aralkyl group in formula (B) include benzyl, phenylethyl, phenylpropyl, 4-phenylbutyl, phenylpentyl, phenylhexyl, phenylheptyl, phenyloctyl, phenylnonyl, naphthylmethyl, naphthylethyl, anthrathylmethyl, and phenyl-cyclopentylmethyl groups.

Examples of the C1-C6 linear alkoxy group in formula (B) include methoxy, ethoxy, n-propoxy, n-butoxy, n-pentyloxy, and n-hexyloxy groups.

Examples of the C3-C6 branched alkoxy group in formula (B) include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group in formula (B) include cyclopropoxy, cyclobutoxy, cyclopentyloxy, and cyclohexyloxy groups.

Preferably, Rb¹ and Rb² in formula (B) are each independently a hydrogen atom, a C1-C12 linear alkyl group, a C1-C12 branched alkyl group, a C6-C10 aryl group, or a C7-C10 aralkyl group, or Rb¹ and Rb² taken together form a C5-C12 cyclic alkyl group.

More preferably, Rb¹ and Rb² in formula (B) are each independently a hydrogen atom, a C1-C10 linear alkyl group, or a C1-C10 branched alkyl group, or Rb¹ and Rb² taken together form a C5-C12 cyclic alkyl group.

Still more preferably, Rb¹ and Rb² in formula (B) are each independently a hydrogen atom, a C1-C10 linear alkyl group, or a C1-C10 branched alkyl group.

Preferably, at least one of Rb¹ and Rb² in formula (B) is a C4-C10 linear alkyl group, a C4-C10 branched alkyl group, a C6-C10 aryl group, or a C7-C10 aralkyl group, or Rb¹ and Rb² taken together form a C5-C12 cyclic alkyl group.

More preferably, at least one of Rb¹ and Rb² in formula (B) is a C4-C10 linear alkyl group, or a C4-C10 branched alkyl group.

When at least one of Rb¹ and Rb² is as described above, the other one of Rb¹ and Rb² may be a hydrogen atom or a C1-C3 linear alkyl group.

The diol unit (B) may be a structural unit represented by formula (B′).

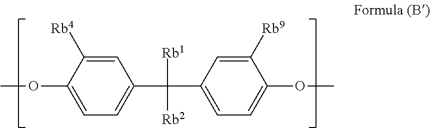

Rb¹, Rb², Rb⁴, and Rb⁹ in formula (B′) respectively have the same definitions as Rb¹, Rb², Rb⁴, and Rb⁹ in formula (B) and may respectively have the same forms as Rb¹, Rb², Rb⁴, and Rb⁹ in formula (B).

In formula (B′), the diol unit (B) preferably has a form where Rb¹ is a hydrogen atom, a C1-C3 linear alkyl group, or a C3 branched alkyl group, and Rb² is a C4-C10 linear alkyl group, or a C4-C10 branched alkyl group, a C6-C10 aryl group, or C7-C10 aralkyl group, and Rb⁴ and Rb⁹ are each independently a hydrogen atom or a methyl group, and the diol unit (B) more preferably has a form where Rb¹ is a hydrogen atom or a methyl group, and Rb² is a C4-C10 linear alkyl group or a C4-C10 branched alkyl group, and Rb⁴ and Rb⁹ are each independently a hydrogen atom or a methyl group.

The diol units (B-1) to (B-38) are shown below as specific examples of the diol unit (B). The diol unit (B) is not limited to these.

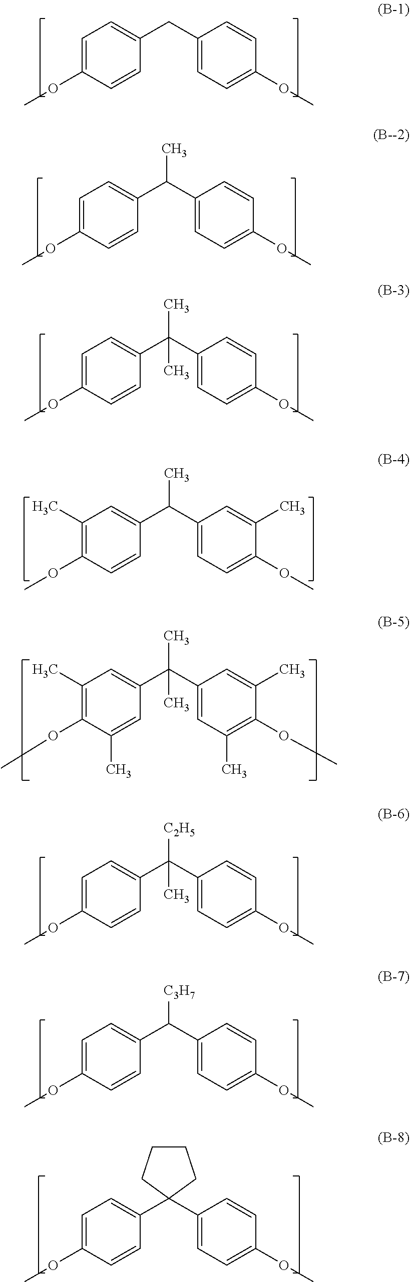

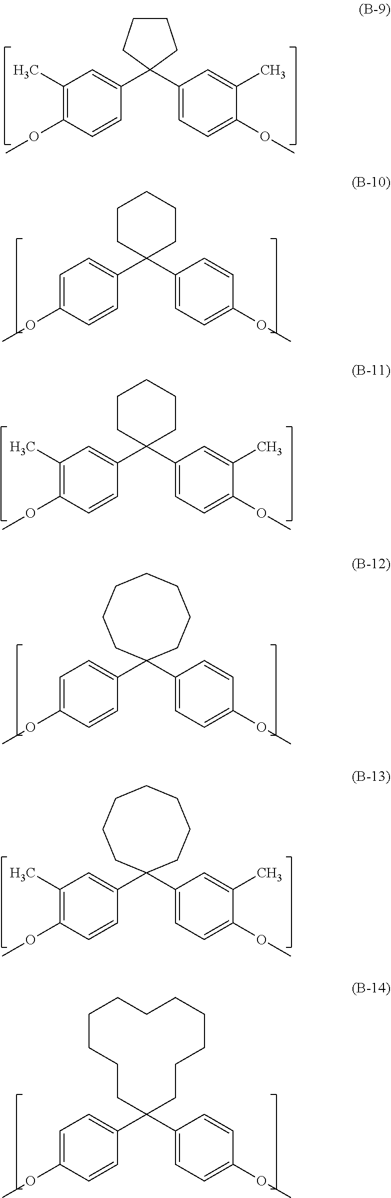

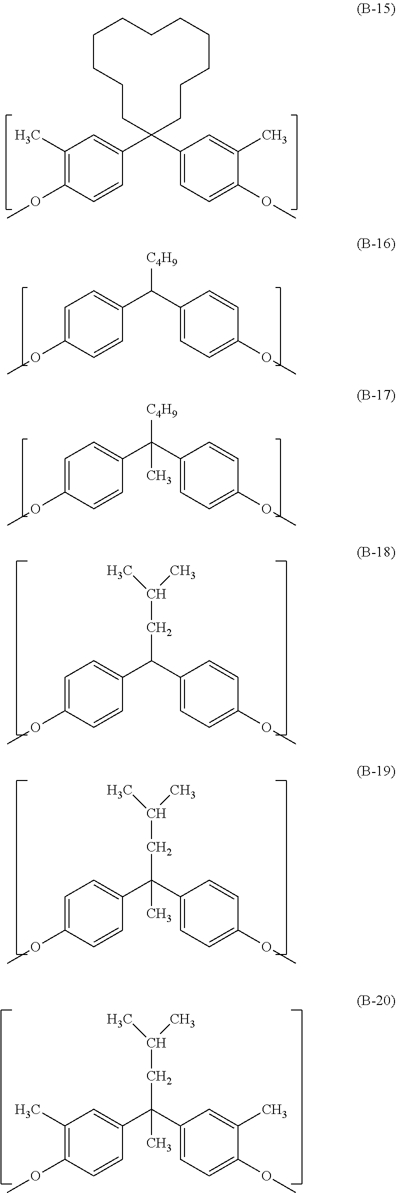

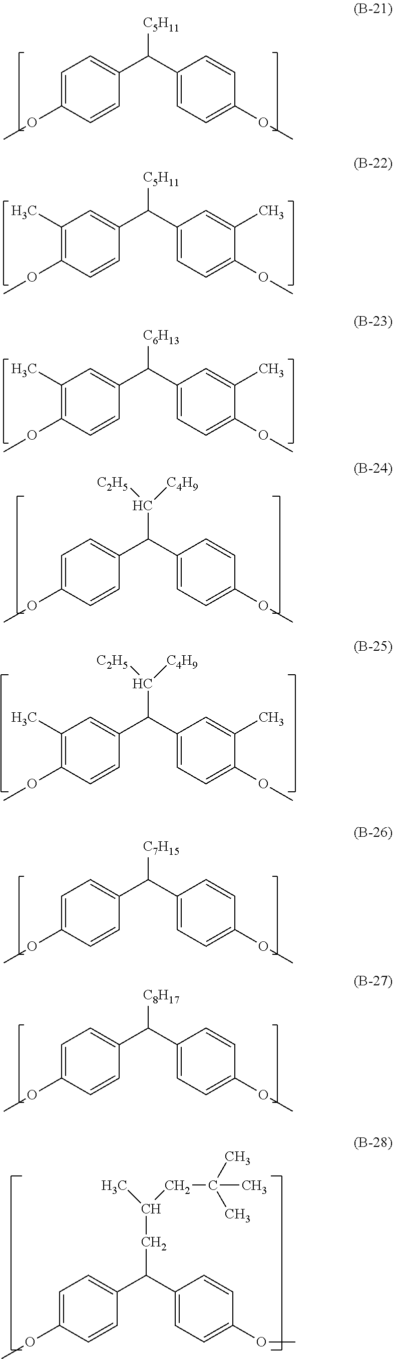

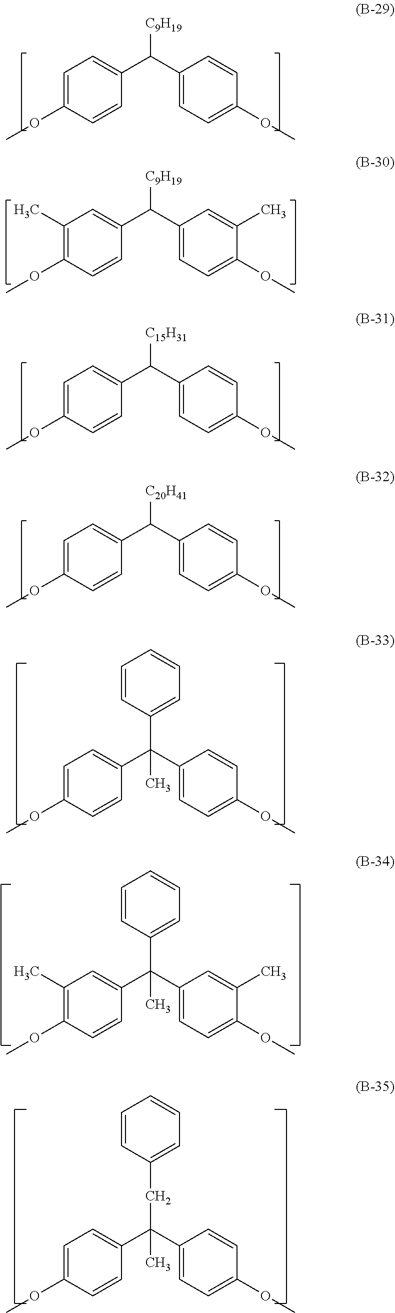

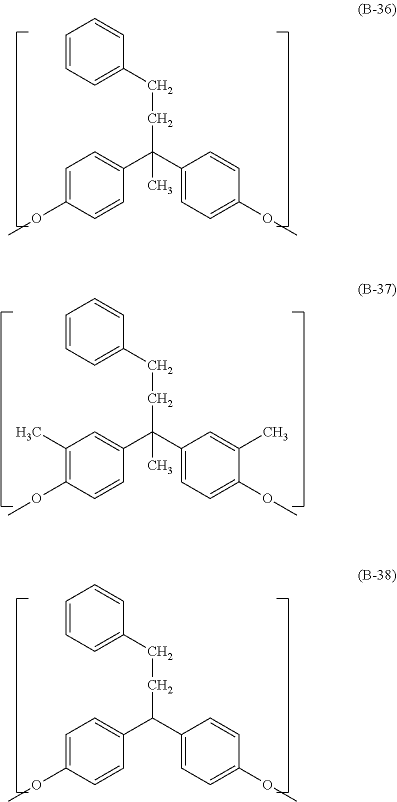

The polyarylate resin (1) may include one type, or two or more types of diol units (B).

The mass ratio of the dicarboxylic acid unit (A) in the polyarylate resin (1) is preferably 15 mass % or more and 60 mass % or less.

When the mass ratio of the dicarboxylic acid unit (A) is 15 mass % or more, the photosensitive layer has high wear resistance. From this viewpoint, the mass ratio of the dicarboxylic acid unit (A) is more preferably 20 mass % or more, still more preferably 25 mass % or more.

When the mass ratio of the dicarboxylic acid unit (A) is 60 mass % or less, the photosensitive layer is less likely to peel off. From this viewpoint, the mass ratio of the dicarboxylic acid unit (A) is more preferably 55 mass % or less, still more preferably 50 mass % or less.

The mass ratio of the diol unit (B) in the polyarylate resin (1) is preferably 25 mass % or more and 60 mass % or less.

When the mass ratio of the diol unit (B) is 25 mass % or more, the photosensitive layer is less likely to peel off. From this viewpoint, the mass ratio of the diol unit (B) is more preferably 30 mass % or more, still more preferably 35 mass % or more.

When the mass ratio of the diol unit (B) is 60 mass % or less, the polyarylate resin (1) may keep solubility in a coating liquid for forming the photosensitive layer and may thus improve wear resistance. From this viewpoint, the mass ratio of the diol unit (B) is more preferably 55 mass % or less, still more preferably 50 mass % or less.

The polyarylate resin (1) may include another dicarboxylic acid unit other than the dicarboxylic acid unit (A).

Examples of another dicarboxylic acid unit include dicarboxylic acid units (C) represented by formula (C).

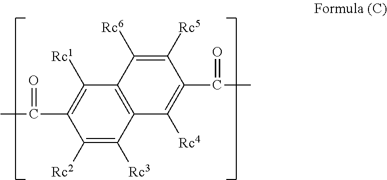

In formula (C), Rc¹, Rc², Rc³, Rc⁴, Rc⁵, and Rc⁶ are each independently a hydrogen atom, a C1-C10 alkyl group, a C6-C12 aryl group, or a C1-C6 alkoxy group.

In formula (C), the C1-C10 alkyl group may be linear, branched, or cyclic. The number of carbon atoms in the alkyl group is preferably 1 or more and 6 or less, more preferably 1 or more and 4 or less, still more preferably 1 or 2.

In formula (C), the C6-C12 aryl group may be monocyclic or polycyclic. The number of carbon atoms in the aryl group is preferably 6 or more and 10 or less, more preferably 6 or more and 9 or less.

In formula (C), the alkyl group in the C1-C6 alkoxy group may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the forms of the alkyl group, the aryl group, and the alkoxy group in formula (C) include the same groups as those described for formula (A).

In formula (C), Rc¹, Rc², Rc³, Rc⁴, Rc⁵, and Rc⁶ are each independently preferably a hydrogen atom, a C1-C6 linear alkyl group, or a C1-C6 branched alkyl group, more preferably a hydrogen atom, a C1-C4 linear alkyl group, or a C1-C4 branched alkyl group, still more preferably a hydrogen atom, a C1-C3 linear alkyl group, or a C1-C3 branched alkyl group, yet still more preferably a hydrogen atom.

The dicarboxylic acid unit (C) may be a 2,6-naphthalene dicarboxylic acid unit (following formula).

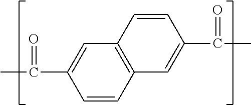

The polyarylate resin (1) may include one type, or two or more types of dicarboxylic acid units (C).

When the polyarylate resin (1) has the dicarboxylic acid unit (C), the mass ratio of the dicarboxylic acid unit (C) in the polyarylate resin (1) may be 1 mass % or more and 20 mass % or less.

Examples of another dicarboxylic acid unit include dicarboxylic acid units (D) represented by formula (D).

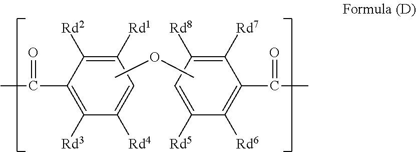

In formula (D), Rd¹, Rd², Rd³, Rd⁴, Rd⁵, Rd⁶, Rd⁷, and Rd⁸ are each independently a hydrogen atom, a C1-C10 alkyl group, a C6-C12 aryl group, or a C1-C6 alkoxy group.

In formula (D), the C1-C10 alkyl group may be linear, branched, or cyclic. The number of carbon atoms in the alkyl group is preferably 1 or more and 6 or less, more preferably 1 or more and 4 or less, still more preferably 1 or 2.

In formula (D), the C6-C12 aryl group may be monocyclic or polycyclic. The number of carbon atoms in the aryl group is preferably 6 or more and 10 or less, more preferably 6 or more and 9 or less.

In formula (D), the alkyl group in the C1-C6 alkoxy group may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the forms of the alkyl group, the aryl group, and the alkoxy group in formula (D) include the same groups as those described for formula (A).

In formula (D), Rd¹, Rd², Rd³, Rd⁴, Rd⁵, Rd⁶, Rd⁷, and Rd⁸ are each independently preferably a hydrogen atom, a C1-C6 linear alkyl group, or a C1-C6 branched alkyl group, more preferably a hydrogen atom, a C1-C4 linear alkyl group, or a C1-C4 branched alkyl group, still more preferably a hydrogen atom, a C1-C3 linear alkyl group, or a C1-C3branched alkyl group, yet still more preferably a hydrogen atom.

The dicarboxylic acid unit (D) may be a structural unit represented by formula (D′).

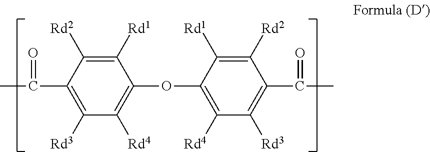

Rd¹, Rd², Rd³, and Rd⁴ in formula (D′) respectively have the same definitions as Rd¹, Rd², Rd³, and Rd⁴ in formula (D) and may respectively have the same forms as Rd¹, Rd², Rd³, and Rd⁴ in formula (D).

The dicarboxylic acid unit (D) may be a diphenyl ether-4,4′-dicarboxylic acid unit (following formula).

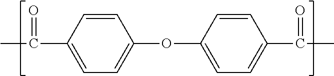

The polyarylate resin (1) may include one type, or two or more types of dicarboxylic acid units (D).

When the polyarylate resin (1) has the dicarboxylic acid unit (D), the mass ratio of the dicarboxylic acid unit (D) in the polyarylate resin (1) may be 1 mass % or more and 20 mass % or less.

Examples of another dicarboxylic acid unit include aliphatic dicarboxylic acid (e.g., oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (e.g., cyclohexanedicarboxylic acid) units, and lower (e.g., C1-C5) alkyl ester units thereof. The polyarylate resin (1) may include one type, or two or more types of these dicarboxylic acid units.

The polyarylate resin (1) may include another diol unit other than the diol unit (B).

Examples of another diol unit include diol units (E) represented by formula (E).

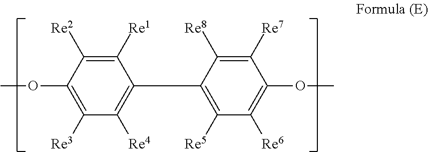

In formula (E), Re¹, Re², Re³, Re⁴, Re⁵, Re⁶, Re⁷, and Re⁸ are each independently a hydrogen atom, a C1-C10 alkyl group, a C6-C12 aryl group, a C7-C20 aralkyl group, or a C1-C6 alkoxy group.

In formula (E), the C1-C10 alkyl group may be linear, branched, or cyclic. The number of carbon atoms in the alkyl group is preferably 1 or more and 6 or less, more preferably 1 or more and 4 or less, still more preferably 1 or 2.

In formula (E), the C6-C12 aryl group may be monocyclic or polycyclic. The number of carbon atoms in the aryl group is preferably 6 or more and 10 or less, more preferably 6 or more and 9 or less.

In formula (E), the aryl group in the C7-C20 aralkyl group may be monocyclic or polycyclic, and the alkyl group in the C7-C20 aralkyl group may be linear, branched, or cyclic. The number of carbon atoms in the aryl group is preferably 6 or more and 10 or less, more preferably 6 or more and 9 or less. The number of carbon atoms in the alkyl group is preferably 1 or more and 6 or less, more preferably 1 or more and 5 or less, still more preferably 1 or more and 4 or less.

In formula (E), the alkyl group in the C1-C6 alkoxy group may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the forms of the alkyl group, the aryl group, the aralkyl group, and the alkoxy group in formula (E) include the same groups as those described for formula (B).

In formula (E), Re¹, Re², Re³, Re⁴, Re⁵, Re⁶, Re⁷, and Re⁸ are each independently preferably a hydrogen atom, a C1-C6 linear alkyl group, or a C1-C6 branched alkyl group, more preferably a hydrogen atom, a C1-C4 linear alkyl group, or a C1-C4 branched alkyl group, still more preferably a hydrogen atom, a C1-C3 linear alkyl group, or a C1-C3 branched alkyl group, yet still more preferably a hydrogen atom or a methyl group.

The diol unit (E) may be a structural unit represented by formula (E′).

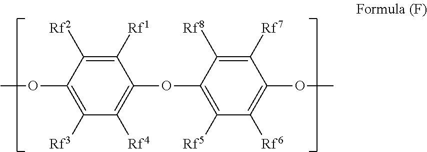

Re¹, Re², Re³, and Re⁴ in formula (E′) respectively have the same definitions as Re¹, Re², Re³, and Re⁴ in formula (E) and may respectively have the same forms as Re¹, Re², Re³, and Re⁴ in formula (E).

The diol unit (E) may be one of the following diol units.

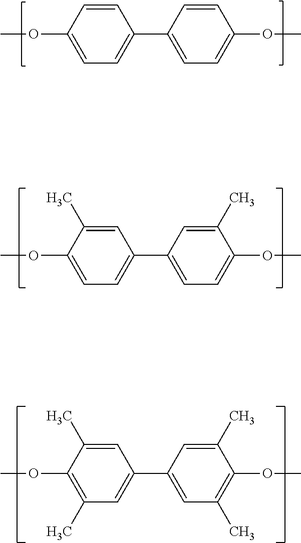

The polyarylate resin (1) may include one type, or two or more types of diol units (E).

When the polyarylate resin (1) has the diol unit (E), the mass ratio of the diol unit (E) in the polyarylate resin (1) may be 1 mass % or more and 20 mass % or less.

Examples of another diol unit include diol units (E) represented by formula (F).

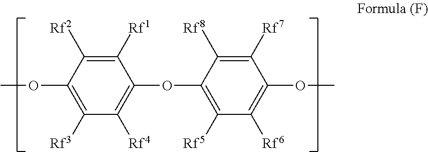

In formula (F), Rf¹, Rf², Rf³, Rf⁴, Rf⁵, Rf⁶, Rf⁷, and Rf⁸ are each independently a hydrogen atom, a C1-C10 alkyl group, a C6-C12 aryl group, a C7-C20 aralkyl group, or a C1-C6 alkoxy group.

In formula (F), the C1-C10 alkyl group may be linear, branched, or cyclic. The number of carbon atoms in the alkyl group is preferably 1 or more and 6 or less, more preferably 1 or more and 4 or less, still more preferably 1 or 2.

In formula (F), the C6-C12 aryl group may be monocyclic or polycyclic. The number of carbon atoms in the aryl group is preferably 6 or more and 10 or less, more preferably 6 or more and 9 or less.

In formula (F), the aryl group in the C7-C20 aralkyl group may be monocyclic or polycyclic, and the alkyl group in the C7-C20 aralkyl group may be linear, branched, or cyclic. The number of carbon atoms in the aryl group is preferably 6 or more and 10 or less, more preferably 6 or more and 9 or less. The number of carbon atoms in the alkyl group is preferably 1 or more and 6 or less, more preferably 1 or more and 5 or less, still more preferably 1 or more and 4 or less.

In formula (F), the alkyl group in the C1-C6 alkoxy group may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the forms of the alkyl group, the aryl group, the aralkyl group, and the alkoxy group in formula (F) include the same groups as those described for formula (B).

In formula (F), Rf¹, Rf², Rf³, Rf⁴, Rf⁵, Rf⁶, Rf⁷, and Rf⁸ are each independently preferably a hydrogen atom, a C1-C6 linear alkyl group, or a C1-C6 branched alkyl group, more preferably a hydrogen atom, a C1-C4 linear alkyl group, or a C1-C4 branched alkyl group, still more preferably a hydrogen atom, a C1-C3 linear alkyl group, or a C1-C3 branched alkyl group, yet still more preferably a hydrogen atom or a methyl group.

The diol unit (F) may be a structural unit represented by formula (F′).

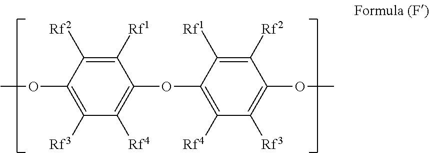

Rf¹, Rf², Rf³, and Rf⁴ in formula (F′) respectively have the same definitions as Rf¹, Rf², Rf³, and Rf⁴ in formula (F) and may respectively have the same forms as Rf¹, Rf², Rf³, and Rf⁴ in formula (F).

The diol unit (F) may be a bis(4-hydroxyphenyl) ether unit (following formula).

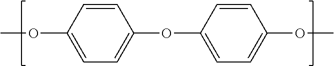

The polyarylate resin (1) may include one type, or two or more types of diol units (F).

When the polyarylate resin (1) has the diol unit (F), the mass ratio of the diol unit (F) in the polyarylate resin (1) may be 1 mass % or more and 20 mass % or less.

Examples of another diol unit include aliphatic diol (e.g., ethylene glycol, diethylene glycol, triethylene glycol, propylene glycol, butanediol, hexanediol, and neopentyl glycol) units, and alicyclic diol (e.g., cyclohexanediol, cyclohexanedimethanol, hydrogenated bisphenol A) units. The polyarylate resin (1) may include one type, or two or more types of these diol units.

The polyarylate resin (1) may be prepared by, for example, polycondensation of a monomer providing the dicarboxylic acid unit (A), a monomer providing the diol unit (B), and other optional monomers in accordance with a conventional method. Examples of monomer polycondensation methods include interfacial polymerization, solution polymerization, and melt polymerization. Interfacial polymerization is a polymerization method in which polyester is produced by mixing a dicarboxylic acid halide dissolved in an organic solvent incompatible with water and a dihydric alcohol dissolved in an aqueous alkaline solution. Examples of documents on interfacial polymerization include W. M. EARECKSON, J. Poly. Sci., XL399, 1959 and Japanese Examined Patent Application Publication No. 40-1959. In interfacial polymerization, the reaction proceeds more quickly than in solution polymerization, so that the dicarboxylic acid halide is less likely to undergo hydrolysis, and as a result, a polyester resin with a high molecular weight may be produced.

The terminals of the polyarylate resin (1) may be capped or modified with a terminal capping agent, a molecular weight regulator, or other agents used in production. Examples of the terminal capping agent or the molecular weight regulator include monohydric phenols, monovalent acid chlorides, monohydric alcohols, and monocarboxylic acids.

Examples of monohydric phenols include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, 2,6-dimethylphenol derivatives, 2-methylphenol derivatives, o-phenylphenol, m-phenylphenol, p-phenylphenol, o-methoxyphenol, m-methoxyphenol, p-methoxyphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of monovalent acid chlorides include monofunctional acid halides, such as benzoyl chloride, benzoic acid chloride, methanesulfonyl chloride, phenyl chloroformate, acetyl chloride, butyryl chloride, octanoyl chloride, benzenesulfonyl chloride, benzenesulfinyl chloride, sulfinyl chloride, benzenephosphonyl chloride, and substituted products thereof.

Examples of monohydric alcohols include methanol, ethanol, n-propanol, isopropanol, n-butanol, 2-butanol, pentanol, hexanol, dodecyl alcohol, stearyl alcohol, benzyl alcohol, and phenethyl alcohol.

Examples of monocarboxylic acids include acetic acid, propionic acid, octanoic acid, cyclohexanecarboxylic acid, benzoic acid, toluic acid, phenylacetic acid, p-tert-butylbenzoic acid, and p-methoxyphenylacetic acid.

The weight average molecular weight of the polyarylate resin (1) is preferably 50,000 or more, more preferably 60,000 or more, still more preferably 70,000 or more, from the viewpoint of the wear resistance of the charge transport layer.

The weight average molecular weight of the polyarylate resin (1) is preferably 400,000 or less, preferably 300,000 or less, still more preferably 250,000 or less, from the viewpoint of the coatability of the charge transport layer and the close contact with the charge generation layer.

The weight average molecular weight of the polyarylate resin (1) in the charge transport layer is measured by the following method.

The photoreceptor is dipped in various solvents (may be mixed solvents) to understand solvents that dissolve the charge transport layer. The photoreceptor is dipped in a solvent that dissolves the charge transport layer such that the charge transport layer is extracted in the solvent. The solvent in which the charge transport layer has been extracted is added dropwise to a poor solvent (e.g., a non-polar solvent, such as hexane or toluene, a lower alcohol, such as methanol and isopropanol. The poor solvent may be a mixed solvent.) for the polyarylate resin (1) to reprecipitate the resin. The reprecipitation process is repeated twice as needed, and the reprecipitate is vacuum-dried to provide the polyarylate resin (1). The polyarylate resin (1) is subjected to molecular weight analysis by GPC (gel permeation chromatography) to determine the weight average molecular weight. In GPC, tetrahydrofuran is used as an eluent, and polystyrene is used as a standard sample.

### Conductive Substrate

Examples of the conductive substrate include metal plates, metal drums, and metal belts made of metals (e.g., aluminum, copper, zinc, chromium, nickel, molybdenum, vanadium, indium, gold, and platinum) or alloys (e.g., stainless steel). Examples of the conductive substrate also include conductive compound (e.g., conductive polymer, indium oxide), metal (e.g., aluminum, palladium, gold), or alloy-coated,-vapor-deposited, or-laminated paper, resin films, and belts. The term “conductive” means that the volume resistivity is less than 1×10¹³ Ω·cm.

The surface of the conductive substrate may be roughened into a center-line average roughness Ra of 0.04 μm or more and 0.5 μm or less in order to prevent or reduce interference fringes generated by irradiation with laser light when the electrophotographic photoreceptor is used in a laser printer. When incoherent light is used as a light source, surface roughening for preventing interference fringes is not necessary, but suitable for longer life since it prevents generation of defects otherwise caused by surface unevenness of the conductive substrate.

Examples of the surface roughening method include: wet honing in which a suspension of an abrasive in water is sprayed onto the conductive substrate; centerless grinding in which the conductive substrate is continuously ground while being pressed against a rotating grindstone; and an anodizing treatment.

Examples of the surface roughening method also include a method in which a dispersion of a conductive or semiconductive powder in a resin is applied to the surface of a conductive substrate to form a layer so that the particles dispersed in the layer form a rough surface, without roughing the surface of the conductive substrate.

The surface roughing treatment by anodization involves anodizing a metal (e.g., aluminum) conductive substrate, which is used as an anode, in an electrolyte solution to form an oxide film on the surface of the conductive substrate. Examples of the electrolyte solution include a sulfuric acid solution and an oxalic acid solution. However, a porous anodized film formed by anodization is chemically active, easily contaminated, and greatly varies in resistance depending on the environment as it is. For this, the porous anodized film may be subjected to pore-sealing in which the fine pores of the anodized film are sealed by volume expansion caused by the hydration reaction in pressurized steam or boiling water (may contain a metal salt, such as a nickel salt), resulting in a more stable hydrated oxide.

The anodized film may have a film thickness of, for example, 0.3 μm or more and 15 μm or less. When the film thickness is in the above range, the anodized film tends to function as a barrier against injection and tends to prevent or reduce an increase in residual potential caused by repeated use.

The conductive substrate may be subjected to the treatment with an acid treatment liquid or the boehmite treatment.

The treatment with an acid treatment liquid is carried out, for example, as described below. First, an acid treatment liquid containing phosphoric acid, chromic acid, and hydrofluoric acid is prepared. With regard to the mixing ratios of phosphoric acid, chromic acid, and hydrofluoric acid in the acid treatment liquid, for example, the mixing ratio of phosphoric acid is in the range of 10 mass % or more and 11 mass % or less, the mixing ratio of chromic acid is in the range of 3 mass % or more and 5 mass % or less, and the mixing ratio of hydrofluoric acid is in the range of 0.5 mass % or more and 2 mass % or less. The total concentration of these acids may be in the range of 13.5 mass % or more and 18 mass % or less. The treatment temperature may be, for example, 42° C. or higher and 48° C. or lower. The coating film may have a film thickness of 0.3 μm or more and 15 μm or less.

The boehmite treatment involves, for example, dipping the conductive substrate in pure water of 90° C. or higher and 100° C. or lower for 5 minutes to 60 minutes or bringing the conductive substrate into contact with hot steam of 90° C. or higher and 120° C. or lower for 5 minutes to 60 minutes. The coating film may have a film thickness of 0.1 μm or more and 5 μm or less. The conductive substrate may be further subjected to the anodizing treatment using an electrolyte solution in which the coating film is less soluble, such as adipic acid, boric acid, a borate salt, a phosphate salt, a phthalate salt, a maleate salt, a benzoate salt, a tartrate salt, or a citrate salt.

The conductive substrate has a diameter of, for example, 20 mm or more and 100 mm or less. The diameter of the conductive substrate is preferably 20 mm or more and 30 mm or less, more preferably 20 mm or more and 24 mm or less, in order to downsize the photoreceptor and the image forming apparatus.

The conductive substrate may be tubular or cylindrical.

### Undercoat Layer

The undercoat layer contains, for example, inorganic particles and a binder resin.

Examples of the inorganic particles include inorganic particles having a powder resistance (volume resistivity) of 1×10² Ω·cm or more and 1×10¹¹ Ω·cm or less.

In particular, the inorganic particles having the above resistance value are, for example, preferably metal oxide particles, such as tin oxide particles, titanium oxide particles, zinc oxide particles, or zirconium oxide particles, more preferably zinc oxide particles.

The inorganic particles may have a BET specific surface area of, for example, 10 m²/g or more.

The inorganic particles may have a volume average particle size of, for example, 50 nm or more and 2000 nm or less (e.g., 60 nm or more and 1000 nm or less).

The amount of the inorganic particles relative to the binder resin is, for example, preferably 10 mass % or more and 80 mass % or less, more preferably 40 mass % or more and 80 mass % or less.

The inorganic particles may be surface-treated. The inorganic particles may be a mixture of two or more types of differently surface-treated inorganic particles or two or more types of inorganic particles having different particle sizes.

Examples of the surface treatment agent include silane coupling agents, titanate coupling agents, aluminum coupling agents, and surfactants. In particular, silane coupling agents are preferred, and silane coupling agents having amino groups are more preferred.

Examples of silane coupling agents having amino groups include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

The silane coupling agents may be used in combination of two or more. For example, a silane coupling agent having an amino group and another silane coupling agent may be used in combination. Examples of another silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method using a surface treatment agent may be any one of known methods and may be a dry method or a wet method.

The amount of the surface treatment agent used may be, for example, 0.5 mass % or more and 10 mass % or less relative to the inorganic particles.

The undercoat layer may contain an electron-accepting compound (acceptor compound) as well as the inorganic particles because this composition improves the long-term stability of electrical properties and the carrier blocking properties.

Examples of the electron-accepting compound include electron-transporting substances, such as compounds having an anthraquinone structure, quinone compounds, such as chloranil and bromoanil; tetracyanoquinodimethane compounds; fluorenone compounds, such as 2,4,7-trinitrofluorenone and 2,4,5,7-tetranitro-9-fluorenone; oxadiazole compounds, such as 2-(4-biphenyl)-5-(4-t-butylphenyl)-1,3,4-oxadiazole, 2,5-bis(4-naphthyl)-1,3,4-oxadiazole, 2,5-bis(4-diethylaminophenyl)-1,3,4-oxadiazole; xanthone compounds; thiophene compounds; diphenoquinone compounds, such as 3,3′,5,5′-tetra-t-butyldiphenoquinone; and benzophenone compounds.

In particular, the electron-accepting compound may be a compound having an anthraquinone structure. Examples of the compound having an anthraquinone structure include hydroxyanthraquinone compounds, aminoanthraquinone compounds, and aminohydroxyanthraquinone compounds. Specific examples include anthraquinone, alizarin, quinizarin, anthralphine, purpurin, and derivatives thereof.

The electron-accepting compound may be dispersed together with the inorganic particles in the undercoat layer, or may be attached to the surfaces of the inorganic particles in the undercoat layer.

Examples of the method for attaching the electron-accepting compound to the surfaces of the inorganic particles include dry methods and wet methods.

An example of dry methods involves, while stirring the inorganic particles in, for example, a mixer with a large shear force, adding an electron-accepting compound dropwise directly or in the form of a solution in an organic solvent or spraying the electron-accepting compound together with dry air or nitrogen gas so that the electron-accepting compound is attached to the surfaces of the inorganic particles. The electron-accepting compound is added dropwise or sprayed at a temperature lower than or equal to the boiling point of the solvent. After the electron-accepting compound is added dropwise or sprayed, baking at 100° C. or higher may further be performed. The temperature and time of baking are not limited as long as the electrophotographic properties are obtained.

An example of wet methods involves, while dispersing the inorganic particles in a solvent by stirring or by using ultrasonic waves, a sand mill, an attritor, or a ball mill, or other means, adding an electron-accepting compound, stirring or dispersing it, and then removing the solvent so that the electron-accepting compound is attached to the surfaces of the inorganic particles. The solvent removal method involves, for example, filtering or evaporating the solvent off. After solvent removal, baking at 100° C. or higher may further be performed. The temperature and time of baking are not limited as long as the electrophotographic properties are obtained. In a wet method, water contained in the inorganic particles may be removed before adding the electron-accepting compound. For example, water may be removed by heating under stirring in the solvent, or water may be removed by boiling together with the solvent.

The attachment of the electron-accepting compound may be performed before or after the inorganic particles are surface-treated with a surface treatment agent, or the attachment of the electron-accepting compound and the surface treatment with a surface treatment agent may be performed at the same time.

The amount of the electron-accepting compound relative to the inorganic particles is, for example, 0.01 mass % or more and 20 mass % or less, preferably 0.01 mass % or more and 10 mass % or less.

Examples of the binder resin used in the undercoat layer include known polymer compounds, such as acetal resins (e.g., polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Examples of the binder resin used in the undercoat layer also include charge-transporting resins having charge-transporting groups, and conductive resins (e.g., polyaniline).

In particular, the binder resin used in the undercoat layer is preferably a resin insoluble in the coating solvent for the overlying layer, more preferably a resin produced by the reaction between a curing agent and at least one resin selected from the group consisting of thermosetting resins, such as urea resins, phenol resins, phenol-formaldehyde resins, melamine resins, urethane resins, unsaturated polyester resins, alkyd resins, and epoxy resins; polyamide resins, polyester resins, polyether resins, methacrylic resins, acrylic resins, polyvinyl alcohol resins, and polyvinyl acetal resins.

When two or more of these binder resins are used in combination, the mixing ratio of the binder resins is set as necessary.

The undercoat layer may contain various additives to improve electrical properties, environmental stability, and image quality.

Examples of the additives include known materials, such as polycyclic condensation-type and azo-type electron-transporting pigments, zirconium chelate compounds, titanium chelate compounds, aluminum chelate compounds, titanium alkoxide compounds, organic titanium compounds, and silane coupling agents. The silane coupling agent is used in the surface treatment of the inorganic particles as described above, but may be added to the undercoat layer as an additive.

Examples of the silane coupling agent used as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of zirconium chelate compounds include zirconium butoxide, ethyl zirconium acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octoate, zirconium naphthenate, zirconium laurate, zirconium stearate, zirconium isostearate, methacrylate zirconium butoxide, stearate zirconium butoxide, and isostearate zirconium butoxide.

Examples of titanium chelate compounds include tetraisopropyl titanate, tetra-n-butyl titanate, butyl titanate dimer, tetra(2-ethylhexyl)titanate, titanium acetylacetonate, polytitanium acetylacetonate, titanium octylene glycolate, titanium lactate ammonium salt, titanium lactate, titanium lactate ethyl ester, titanium triethanolaminate, and polyhydroxytitanium stearate.

Examples of the aluminum chelate compounds include aluminum isopropylate, monobutoxyaluminum diisopropylate, aluminum butyrate, ethyl acetoacetate aluminum diisopropylate, and aluminum tris(ethylacetoacetate).

These additives may be used singly or used as a mixture or polycondensate of two or more compounds.

The undercoat layer may have a Vickers hardness of 35 or more.

To prevent or reduce moire fringes, the surface roughness (ten-point average roughness) of the undercoat layer may be adjusted in the range of from 1/(4n) (where n represents the refractive index of the overlying layer) to ½ of the laser wavelength λ used for exposure.

To adjust the surface roughness, the undercoat layer may contain resin particles and the like. Examples of the resin particles include silicone resin particles and cross-linked polymethyl methacrylate resin particles. The surface of the undercoat layer may be polished to adjust the surface roughness. Examples of the polishing method include buff polishing, sand blasting, wet honing, and grinding.

The undercoat layer may be formed by any one of known forming methods. For example, a coating liquid for forming the undercoat layer is prepared by adding the above components to a solvent, and a coating film of the coating liquid is formed, dried, and heated as needed.

Examples of the solvent used for preparing the coating liquid for forming the undercoat layer include known organic solvents, such as alcohol solvents, aromatic hydrocarbon solvents, halogenated hydrocarbon solvents, ketone solvents, ketone-alcohol solvents, ether solvents, and ester solvents.

Specific examples of these solvents include common organic solvents, such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing the inorganic particles to prepare the coating liquid for forming the undercoat layer include known methods using a roll mill, a ball mill, a vibrating ball mill, an attritor, a sand mill, a colloid mill, a paint shaker, or the like.

Examples of the method for applying the coating liquid for forming the undercoat layer onto the conductive substrate include common methods, such as a blade coating method, a wire bar coating method, a spray coating method, a dip coating method, a bead coating method, an air knife coating method, and a curtain coating method.

The thickness of the undercoat layer is preferably set to, for example, 15 μm or more, more preferably in the range of 20 μm or more and 50 μm or less.

### Intermediate Layer

An intermediate layer may be further disposed between the undercoat layer and the photosensitive layer.

The intermediate layer is, for example, a layer containing a resin. Examples of the resin used in the intermediate layer include polymer compounds, such as acetal resins (e.g., polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer containing an organometallic compound. Examples of the organometallic compound used in the intermediate layer include organometallic compounds containing a metal atom, such as zirconium, titanium, aluminum, manganese, or silicon.

These compounds used in the intermediate layer may be used singly or used as a mixture or polycondensate of two or more compounds.

In particular, the intermediate layer may be a layer containing an organometallic compound containing a zirconium atom or a silicon atom.

The intermediate layer may be formed by any one of known forming methods. For example, a coating liquid for forming the intermediate layer is prepared by adding the above components to a solvent, and a coating film of the coating liquid is formed, dried, and heated as needed.

Examples of the coating method for forming the intermediate layer include common methods, such as a dip coating method, a lift coating method, a wire bar coating method, a spray coating method, a blade coating method, an air knife coating method, and a curtain coating method.

The thickness of the intermediate layer may be set, for example, in the range of 0.1 μm or more and 3 μm or less. The intermediate layer may be used as the undercoat layer.

### Charge Generation Layer

The charge generation layer is, for example, a layer containing a charge generating material and a binder resin. The charge generation layer may be a layer formed by vapor deposition of the charge generating material. The layer formed by vapor deposition of a charge generating material is suitable for the case of using an incoherent light source, such as a light emitting diode (LED) or an organic electro-luminescence (EL) image array.

Examples of the charge generating material include azo pigments, such as bisazo and trisazo pigments; fused-ring aromatic pigments, such as dibromoanthanthrone; perylene pigments; pyrrolopyrrole pigments; phthalocyanine pigments; zinc oxide; and trigonal selenium.

For laser exposure in the near-infrared region, the charge generating material is preferably a metal phthalocyanine pigment or a metal-free phthalocyanine pigment. Specifically, for example, hydroxygallium phthalocyanine, chlorogallium phthalocyanine, dichlorotin phthalocyanine, and titanyl phthalocyanine are more preferred.

For laser exposure in the near-ultraviolet region, the charge generating material is preferably, for example, a fused-ring aromatic pigment, such as dibromoanthanthrone, a thioindigo pigment, a porphyrazine compound, zinc oxide, trigonal selenium, or a bisazo pigment.

In the case of using an incoherent light source, such as an LED or organic EL image array having an emission center wavelength of 450 nm or more and 780 nm or less, the charge generating material described above may also be used.

When an n-type semiconductor, such as a fused-ring aromatic pigment, a perylene pigment, or an azo pigment, is used as the charge generating material, a dark current is difficult to generate, and image defects called black spots may be prevented or reduced even in a thin film. Whether the material is of n-type or not is determined by using a common time- of-flight method on the basis of the polarity of a flowing photocurrent, and a material that allows electrons to flow more easily as carriers than holes is determined to be of n-type.

The binder resin used in the charge generation layer is selected from a wide range of insulating resins, and may be selected from organic photoconductive polymers, such as poly-N-vinylcarbazole, polyvinyl anthracene, polyvinyl pyrene, and polysilane.

Examples of the binder resin include polyvinyl butyral resins, polyarylate resins (e.g., polycondensates of bisphenols and divalent aromatic carboxylic acids), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinylpyrrolidone resins. The term “insulating” as used herein means that the volume resistivity is 1×10¹³ Ω·cm or more.

These binder resins are used singly or in combination of two or more.

The blending ratio of the charge generating material to the binder resin may be in the range of from 10:1 to 1:10 in terms of mass ratio.

The charge generation layer may contain other known additives.

The charge generation layer may be formed by any one of known forming methods. For example, a coating liquid for forming the charge generation layer is prepared by adding the above components to a solvent, and a coating film of the coating liquid is formed, dried, and heated as needed. The charge generation layer may be formed by vapor deposition of the charge generating material. The charge generation layer may be formed by vapor deposition in the case of using a fused-ring aromatic pigment or a perylene pigment as the charge generating material.

Examples of the solvent used for preparing the coating liquid for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used singly or in combination of two or more.

Examples of the method for dispersing particles (e.g., charge generating material) in the coating liquid for forming the charge generation layer include methods using a media disperser, such as a ball mill, a vibrating ball mill, an attritor, a sand mill, or a horizontal sand mill, or a medialess disperser, such as a stirrer, an ultrasonic disperser, a roll mill, or a high-pressure homogenizer. Examples of the high-pressure homogenizer include a collision-type homogenizer in which a dispersion is formed through liquid-liquid collision or liquid-wall collision under high pressure, and a penetration-type homogenizer in which a dispersion is formed by causing the mixture to penetrate through a fine flow path under high pressure.

This dispersion is effectively formed when the charge generating material in the coating liquid for forming the charge generation layer has an average particle size of 0.5 μm or less, preferably 0.3 μm or less, more preferably or 0.15 μm or less.

Examples of the method for applying the coating liquid for forming the charge generation layer onto the undercoat layer (or onto the intermediate layer) include common methods, such as a blade coating method, a wire bar coating method, a spray coating method, a dip coating method, a bead coating method, an air knife coating method, and a curtain coating method.

The thickness of the charge generation layer is preferably set, for example, in the range of 0.1 μm or more and 5.0 μm or less, more preferably in the range of 0.2 μm or more and 2.0 μm or less.

### Charge Transport Layer

The charge transport layer contains a charge-transporting material and a polyarylate resin (1).

Examples of the charge-transporting material include electron-transporting compounds, such as quinone compounds, such as p-benzoquinone, chloranil, bromanil, anthraquinone; tetracyanoquinodimethane compounds; fluorenone compounds, such as 2,4,7-trinitrofluorenone; xanthone compounds; benzophenone compounds; cyanovinyl compounds; and ethylene compounds. Examples of the charge-transporting material also include hole-transporting compounds, such as triarylamine compounds, benzidine compounds, arylalkane compounds, aryl-substituted ethylene compounds, stilbene compounds, anthracene compounds, and hydrazone compounds. These charge-transporting materials are used singly or in combination of two or more. The charge-transporting materials are not limited to these compounds.

From the viewpoint of charge mobility, the charge-transporting material is preferably a triarylamine derivative represented by structural formula (a-1) or a benzidine derivative represented by structural formula (a-2).

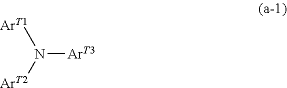

In structural formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent for each of the groups described above include halogen atoms, C1-C5 alkyl groups, and C1-C5 alkoxy groups. Examples of the substituent for each of the groups described above also include substituted amino groups substituted by a C1-C3 alkyl group.

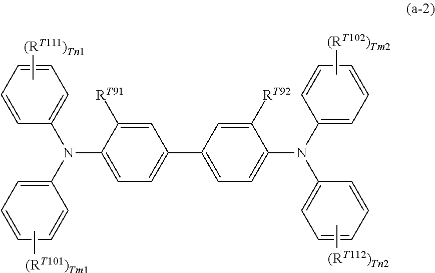

In structural formula (a-2), R^{T91} and R^{T92} each independently represent a hydrogen atom, a halogen atom, a C1-C5 alkyl group, or a C1-C5 alkoxy group. R^{T101}, R^{T102}, R^{T111}, and R^{T112} each independently represent a halogen atom, a C1-C5 alkyl group, a C1-C5 alkoxy group, an amino group substituted by a C1-C2 alkyl group, a substituted or unsubstituted aryl group, —C(R^{T12})═C(R^{T13})(R^{T14}), or —CH═CH—CH═C(R^{T15})(R^{T16}), where R^{T12}, R^{T13}, R^{T14}, R^{T15}, and R^{T16} each independently represent a hydrogen atom, a substituted or unsubstituted alkyl group, or a substituted or unsubstituted aryl group. Tml, Tm2, Tn1, and Tn2 each independently represent an integer of 0 or more and 2 or less.

Examples of the substituent for each of the groups described above include halogen atoms, C1-C5 alkyl groups, and C1-C5 alkoxy groups. Examples of the substituent for each of the groups described above also include substituted amino groups substituted by a C1-C3 alkyl group.

Of the triarylamine derivatives represented by structural formula (a-1) and the benzidine derivatives represented by structural formula (a-2), a triarylamine derivative having “—C₆H₄—CH═CH—CH═C(R^{T7}) (R^{T8})” and a benzidine derivative having “—CH═CH—CH═C(R^{T15})(R^{T16})” may be used from the viewpoint of charge mobility.

Examples of polymer charge-transporting materials include known polymer materials having charge-transporting properties, such as poly-N-vinylcarbazole or polysilane. In particular, polyester polymer charge-transporting materials may be used.

From the viewpoint of the electrical properties of the photoreceptor, the charge-transporting material may contain at least one selected from the group consisting of compounds represented by formula (1), compounds represented by formula (2), compounds represented by formula (3), and compounds represented by formula (4).

In the present disclosure, the compounds represented by formula (1) are referred to as “compounds (1),” the compounds represented by formula (2) as “compounds (2),” the compounds represented by formula (3) as “compounds (3),” the compounds represented by formula (4) as “compounds (4).”

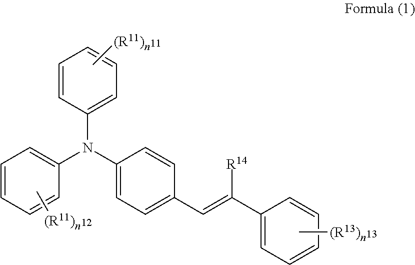

In formula (1), n¹¹ is an integer of 0 or more and 5 or less, n¹¹ R¹¹'s are each independently a C1-C6 alkyl group or a C1-C6 alkoxy group, and n¹² is an integer of 0 or more and 5 or less, and n¹² R¹²'s are each independently a C1-C6 alkyl group or a C1-C6 alkoxy group, n¹³ is an integer of 0 or more and 5 or less, and n¹³ R¹³'s are each independently a C1-C6 alkyl group or a C1-C6 alkoxy group, and R¹⁴ is a hydrogen atom, a C1-C8 alkyl group, a C1-C8 alkoxy group, or a phenyl group optionally substituted by a C1-C8 alkyl group.

In formula (1), R¹¹, R¹², R¹³, and R¹⁴ are each independently preferably a C1-C4 alkyl group or a C1-C4 alkoxy group, more preferably a C1-C3 alkyl group or a C1-C3 alkoxy group, still more preferably a C1-C2 alkyl group or a C1-C2 alkoxy group, yet still more preferably a methyl group or a methoxy group.

In formula (1), n¹¹, n¹², and n¹³ are each independently preferably an integer of 0 or more and 3 or less, more preferably an integer of 0 or more and 2 or less, yet still more preferably 0 or 1.

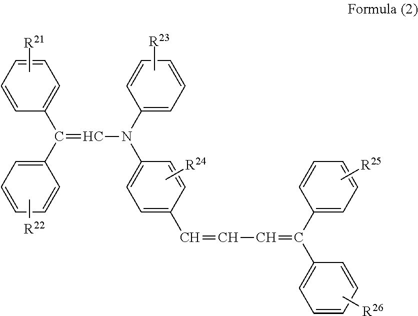

In formula (2), R²¹, R²², R²³, R²⁴, R²⁵, and R²⁶ are each independently a hydrogen atom, a halogen atom, a C1-C20 alkyl group, a C1-C20 alkoxy group, or a substituted or unsubstituted C6-C30 aryl group, and adjacent substituents taken together optionally form a hydrocarbon ring structure.

Examples of substituents that substitute the aryl group in formula (2) include halogen atoms, C1-C4 alkyl groups, C1-C4 alkoxy groups, and a phenyl group.

In formula (2), R²¹, R²², R²³, R²⁴, R²⁵, and R²⁶ are each independently preferably a hydrogen atom, a C1-C4 alkyl group, or a C1-C4 alkoxy group, more preferably a hydrogen atom, a C1-C3 alkyl group, or a C1-C3 alkoxy group, still more preferably a hydrogen atom, a C1-C2 alkyl group, or a C1-C2 alkoxy group, yet still more preferably a hydrogen atom, a methyl group, or a methoxy group.

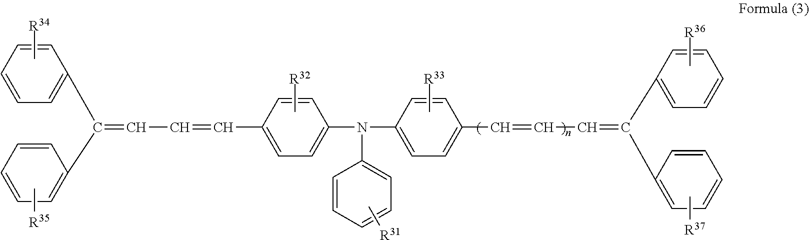

In formula (3), R³¹, R³², R³³, R³⁴, R³⁵, R³⁶, and R³⁷ are each independently a hydrogen atom, a halogen atom, a C1-C20 alkyl group, a C1-C20 alkoxy group, or a substituted or unsubstituted C6-C30 aryl group, and n is 0 or 1.

Examples of substituents that substitute the aryl group in formula (3) include halogen atoms, C1-C4 alkyl groups, C1-C4 alkoxy groups, and a phenyl group.

In formula (3), R³¹, R³², R³³, R³⁴, R³⁵, R³⁶, and R³⁷ are each independently preferably a hydrogen atom, a C1-C4 alkyl group, or a C1-C4 alkoxy group, more preferably a hydrogen atom, a C1-C3 alkyl group, or a C1-C3 alkoxy group, still more preferably a hydrogen atom, a C1-C2 alkyl group, or a C1-C2 alkoxy group, yet still more preferably a hydrogen atom, a methyl group, or a methoxy group.

In formula (3), n may be 1.

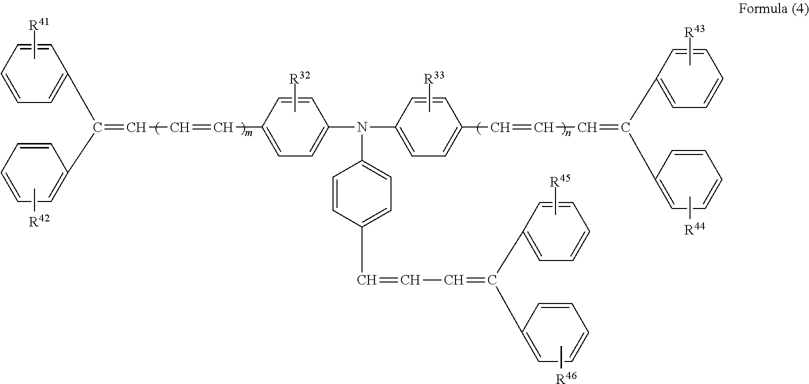

In formula (4), R⁴¹, R⁴², R⁴³, R⁴⁴, R⁴⁵, and R⁴⁶ are each independently a hydrogen atom, a halogen atom, a C1-C20 alkyl group, a C1-C20 alkoxy group, or a substituted or unsubstituted C6-C30 aryl group, m is 0 or 1, and n is 0 or 1.

Examples of substituents that substitute the aryl group in formula (4) include halogen atoms, C1-C4 alkyl groups, C1-C4 alkoxy groups, and a phenyl group.

In formula (4), R⁴¹, R⁴², R⁴³, R⁴⁴, R⁴⁵, and R⁴⁶ are each independently preferably a hydrogen atom, a C1-C4 alkyl group, or a C1-C4 alkoxy group, more preferably a hydrogen atom, a C1-C3 alkyl group, or a C1-C3 alkoxy group, still more preferably a hydrogen atom, a C1-C2 alkyl group, or a C1-C2 alkoxy group, yet still more preferably a hydrogen atom, a methyl group, or a methoxy group.

In formula (4), m may be 1, and n may be 1.

Tables 1 and 2 show the compounds (3-1) to (3-32) as specific examples of the compound (3). The compounds (3) are not limited to these compounds. In Tables 1 to 2, “-Me” means a methyl group, “-OMe” means a methoxy group, and the number attached to “-Me” and “-OMe” means the position on the benzene ring.

TABLE 1

| Compound | n | R³¹ | R³² | R³³ | R³⁴ | R³⁵ | R³⁶ | R³⁷ |
|---|---|---|---|---|---|---|---|---|
| 3-1 | 0 | H | H | H | H | H | H | H |
| 3-2 | 0 | H | H | 3-Me | H | H | 4-Me | 4-Me |
| 3-3 | 0 | H | H | H | 4-Me | H | 4-Me | H |
| 3-4 | 0 | H | H | H | 4-Me | 4-Me | H | H |
| 3-5 | 0 | 4-Me | H | H | H | H | H | H |
| 3-6 | 0 | 4-Me | 3-Me | 3-Me | H | H | 4-Me | 4-Me |
| 3-7 | 0 | 4-Me | H | H | 4-Me | H | 4-Me | H |
| 3-8 | 0 | 4-Me | H | H | 3-Me | H | 3-Me | H |
| 3-9 | 0 | 2-Me | H | H | H | H | H | H |
| 3-10 | 0 | 2-Me | H | H | H | H | 4-Me | 4-Me |
| 3-11 | 0 | 2-Me | H | H | 4-Me | H | 4-Me | H |
| 3-12 | 0 | 2-Me | H | 3-Me | 3-Me | H | 3-Me | H |
| 3-13 | 0 | 4-OMe | H | H | H | H | H | H |
| 3-14 | 0 | 4-OMe | H | H | H | H | 4-Me | 4-Me |
| 3-15 | 0 | 4-OMe | H | H | 4-Me | H | 4-Me | H |
| 3-16 | 0 | 4-OMe | H | H | 3-Me | H | 3-Me | H |

TABLE 2

| Compound | n | R³¹ | R³² | R³³ | R³⁴ | R³⁵ | R³⁶ | R³⁷ |
|---|---|---|---|---|---|---|---|---|
| 3-17 | 1 | H | H | H | H | H | H | H |
| 3-18 | 1 | H | H | 3-Me | H | H | 4-Me | 4-Me |
| 3-19 | 1 | H | H | H | 4-Me | H | 4-Me | H |
| 3-20 | 1 | H | H | H | 4-Me | 4-Me | H | H |
| 3-21 | 1 | 4-Me | H | H | H | H | H | H |
| 3-22 | 1 | 4-Me | 3-Me | 3-Me | H | H | 4-Me | 4-Me |
| 3-23 | 1 | 4-Me | H | H | 4-Me | H | 4-Me | H |
| 3-24 | 1 | 4-Me | H | H | 3-Me | H | 3-Me | H |
| 3-25 | 1 | 2-Me | H | H | H | H | H | H |
| 3-26 | 1 | 2-Me | H | H | H | H | 4-Me | 4-Me |
| 3-27 | 1 | 2-Me | H | H | 4-Me | H | 4-Me | H |
| 3-28 | 1 | 2-Me | H | 3-OMe | 3-Me | H | 3-Me | H |
| 3-29 | 1 | 4-OMe | H | H | H | H | H | H |
| 3-30 | 1 | 4-OMe | H | H | H | H | 4-Me | 4-Me |
| 3-31 | 1 | 4-OMe | H | H | 4-Me | H | 4-Me | H |
| 3-32 | 1 | 4-OMe | H | H | 3-Me | H | 3-Me | H |

Table 3 shows the compounds (4-1) to (4-20) as specific examples of the compound (4). The compounds (4) are not limited to these compounds. In Table 3, “-Me” means a methyl group, “-OMe” means a methoxy group, and the number attached to “-Me” and “-OMe” means the position on the benzene ring.

TABLE 3

| Com- | | | | | | | | |
|---|---|---|---|---|---|---|---|---|
| pound | n | m | R⁴¹ | R⁴² | R⁴³ | R⁴⁴ | R⁴⁵ | R⁴⁶ |
| 4-1 | 1 | 0 | H | H | H | H | H | H |
| 4-2 | 1 | 0 | 4-Me | 4-Me | 4-Me | 4-Me | 4-Me | 4-Me |
| 4-3 | 1 | 0 | 4-Me | 4-Me | H | H | 4-Me | 4-Me |
| 4-4 | 1 | 0 | H | H | 4-Me | 4-Me | H | H |
| 4-5 | 1 | 0 | H | H | 3-Me | 3-Me | H | H |
| 4-6 | 1 | 0 | 4-Me | H | H | H | 4-Me | H |
| 4-7 | 1 | 0 | 4-OMe | H | H | H | 4-OMe | H |
| 4-8 | 1 | 0 | H | H | 4-OMe | 4-OMe | H | H |
| 4-9 | 1 | 0 | 4-OMe | H | 4-OMe | H | 4-OMe | 4-OMe |
| 4-10 | 1 | 0 | 3-Me | H | 3-Me | H | 3-Me | H |
| 4-11 | 1 | 1 | H | H | H | H | H | H |
| 4-12 | 1 | 1 | 4-Me | 4-Me | 4-Me | 4-Me | 4-Me | 4-Me |
| 4-13 | 1 | 1 | 4-Me | 4-Me | H | H | 4-Me | 4-Me |
| 4-14 | 1 | 1 | H | H | 4-Me | 4-Me | H | H |
| 4-15 | 1 | 1 | H | H | 3-Me | 3-Me | H | H |
| 4-16 | 1 | 1 | 4-Me | H | H | H | 4-Me | H |
| 4-17 | 1 | 1 | 4-OMe | H | H | H | 4-OMe | H |
| 4-18 | 1 | 1 | H | H | 4-OMe | 4-OMe | H | H |
| 4-19 | 1 | 1 | 4-OMe | H | 4-OMe | H | 4-OMe | 4-OMe |
| 4-20 | 1 | 1 | 3-Me | H | 3-Me | H | 3-Me | H |

Of the compounds (1), the compounds (2), the compounds (3), and the compounds (4), the compounds (1), the compounds (2), and the compounds (3) are preferred, and the compounds (1) and the compounds (2) are more preferred from the viewpoint of the electrical properties of the photoreceptor.

The amount of the charge-transporting material contained in the charge transport layer relative to the mass of the charge transport layer is 56 mass % or more and 70 mass % or less, preferably 58 mass % or more and 68 mass % or less, more preferably 60 mass % or more and 65 mass % or less.

The charge transport layer contains at least the polyarylate resin (1) as a binder resin. The proportion of the polyarylate resin (1) relative to the total amount of resins contained in the charge transport layer is preferably 50 mass % or more, more preferably 80 mass % or more, still more preferably 90 mass % or more, yet still more preferably 95 mass %, most preferably 100 mass %.

The charge transport layer may contain another binder resin other than the polyarylate resin (1). Examples of another binder resin include polyester resins other than the polyarylate resin (1), polycarbonate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. These binder resins are used singly or in combination of two or more.

The charge transport layer according to an exemplary embodiment contains the polyarylate resin (1) and a polycarbonate resin as binder resins. In this case, the mass ratio of both resins may be the polyarylate resin (1):the polycarbonate resin=95:5 to 30:70.

The polycarbonate resin may be a polycarbonate resin with repeating structural units having aromatic rings. Specific examples of the polycarbonate resin include polycarbonate resins used in Examples below.

The charge transport layer may contain other known additives. Examples of the additives include antioxidants, leveling agents, anti-foaming agents, fillers, and viscosity modifiers.

The charge transport layer may be formed by any one of known forming methods. For example, a coating liquid for forming the charge transport layer is prepared by adding the above components to a solvent, and a coating film of the coating liquid is formed, dried, and heated as needed.

Examples of the solvent used for preparing the coating liquid for forming the charge transport layer include aromatic hydrocarbons, such as benzene, toluene, xylene, and chlorobenzene; ketones, such as acetone and 2-butanone; halogenated aliphatic hydrocarbons, such as methylene chloride, chloroform, and ethylene chloride; and ordinary organic solvents, such as cyclic or linear ethers, such as tetrahydrofuran and ethyl ether. These solvents are used singly or in combination of two or more.

Examples of the application method for applying the coating liquid for forming the charge transport layer onto the charge generation layer include common methods, such as a blade coating method, a wire bar coating method, a spray coating method, a dip coating method, a bead coating method, an air knife coating method, and a curtain coating method.

The thickness of the charge transport layer is preferably set, for example, in the range of 5 μm or more and 50 μm or less, more preferably in the range of 10 μm or more and 40 μm or less.

### Protective Layer

The protective layer is disposed on the photosensitive layer as needed. The protective layer is disposed for the purpose of, for example, preventing chemical changes in the photosensitive layer during charging or further improving the mechanical strength of the photosensitive layer.

For this, the protective layer may be composed of a cured film (cross-linked film). Examples of the cured film include layers described below in 1) or 2).

1) A layer composed of a cured film of a composition containing a reactive group-containing charge-transporting material having a reactive group and a charge transportable skeleton in the same molecule (i.e., a layer containing a polymer or cross-linked product of the reactive group-containing charge-transporting material)

2) A layer composed of a cured film of a composition containing a non-reactive charge-transporting material and a reactive group-containing non-charge-transporting material having a reactive group but not having a charge transportable skeleton (i.e., a layer containing the non-reactive charge-transporting material and a polymer or cross-linked product of the reactive group-containing non-charge-transporting material)

Examples of the reactive group of the reactive group-containing charge-transporting material include known reactive groups, such as chain polymerization groups, an epoxy group, —OH, —OR [wherein R represents an alkyl group], —NH₂, —SH, —COOH, and —SiR^{Q1}_{3-Qn}(OR^{Q2})_{Qn} [wherein R^{Q1} represents a hydrogen atom, an alkyl group, or a substituted or unsubstituted aryl group, and R^{Q2} represents a hydrogen atom, an alkyl group, or a trialkylsilyl group. Qn represents an integer of 1 to 3].

The chain polymerization groups are any of functional groups that may undergo radical polymerization and are, for example, functional groups having at least a carbon double bond. Specific examples of the chain polymerizable groups include groups containing at least one selected from vinyl groups, vinyl ether groups, vinyl thioether groups, phenyl vinyl groups, vinyl phenyl groups, acryloyl groups, methacryloyl groups, and derivatives thereof. The chain polymerization groups may contain at least one selected from vinyl groups, phenyl vinyl groups, vinyl phenyl groups, acryloyl groups, methacryloyl groups, and derivatives thereof due to their high reactivity.

The charge transportable skeleton of the reactive group-containing charge-transporting material may have any structure known in the electrophotographic photoreceptor. Examples of the charge transportable skeleton include skeletons that are derived from nitrogen-containing hole-transporting compounds, such as triarylamine compounds, benzidine compounds, and hydrazone compounds, and that have structures conjugated with nitrogen atoms. The charge transportable skeleton may be a triarylamine skeleton among these.

The reactive group-containing charge-transporting material having a reactive group and a charge transportable skeleton, the non-reactive charge-transporting material, and the reactive group-containing non-charge-transporting material are selected from known materials.

The protective layer may contain other known additives.

The protective layer may be formed by any one of known forming methods. For example, a coating liquid for forming the protective layer is prepared by adding the above components to a solvent, and a coating film of the coating liquid is formed, dried, and cured by heating or other processes as needed.

Examples of the solvent used for preparing the coating liquid for forming the protective layer include aromatic solvents, such as toluene and xylene; ketone solvents, such as methyl ethyl ketone, methyl isobutyl ketone, and cyclohexanone; ester solvents, such as ethyl acetate and butyl acetate; ether solvents, such as tetrahydrofuran and dioxane; cellosolve solvents, such as ethylene glycol monomethyl ether; and alcohol solvents, such as isopropyl alcohol and butanol. These solvents are used singly or in combination of two or more. The coating liquid for forming the protective layer may be a solvent-free coating liquid.

Examples of the method for applying the coating liquid for forming the protective layer onto the photosensitive layer (e.g., charge transport layer) include common methods, such as a dip coating method, a lift coating method, a wire bar coating method, a spray coating method, a blade coating method, an air knife coating method, and a curtain coating method.

The thickness of the protective layer is preferably set, for example, in the range of 1 μm or more and 20 μm or less, more preferably in the range of 2 μm or more and 10 μm or less.

### Image Forming Apparatus, Process Cartridge

An image forming apparatus according to an exemplary embodiment includes: an electrophotographic photoreceptor; a charging device that charges the surface of the electrophotographic photoreceptor; an electrostatic latent image-forming device that forms an electrostatic charge image on the charged surface of the electrophotographic photoreceptor; a developing device that develops the electrostatic latent image on the surface of the electrophotographic photoreceptor by using a developer containing a toner to form a toner image; and a transfer device that transfers the toner image to the surface of a recording medium. The electrophotographic photoreceptor according to the exemplary embodiment is used as an electrophotographic photoreceptor.

The image forming apparatus according to the exemplary embodiment may be a known image forming apparatus, such as an apparatus including a fixing device that fixes a toner image that has been transferred to the surface of a recording medium; a direct transfer-type apparatus in which a toner image formed on the surface of an electrophotographic photoreceptor is directly transferred to a recording medium; an intermediate transfer-type apparatus in which a toner image formed on the surface of an electrophotographic photoreceptor is first transferred to the surface of an intermediate transfer body, and the toner image, which has been transferred to the surface of the intermediate transfer body, is second transferred to the surface of a recording medium; an apparatus including a cleaning device that cleans the surface of an electrophotographic photoreceptor before charging after transfer of a toner image; an apparatus including a discharging device that discharges the surface of an electrophotographic photoreceptor by irradiating the surface of the electrophotographic photoreceptor with discharging light before charging after transfer of a toner image; and an apparatus including an electrophotographic photoreceptor-heating member for increasing the temperature of an electrophotographic photoreceptor to reduce the relative temperature.

In an intermediate transfer-type apparatus, the transfer device includes, for example, an intermediate transfer body having the surface to which a toner image is transferred, a first transfer device that first transfers the toner image on the surface of the electrophotographic photoreceptor to the surface of the intermediate transfer body, and a second transfer device that second transfers the toner image, which has been transferred to the surface of the intermediate transfer body, to the surface of a recording medium.

The image forming apparatus according to the exemplary embodiment may be either a dry development-type image forming apparatus or a wet development-type (development type using a liquid developer) image forming apparatus.

In the image forming apparatus according to the exemplary embodiment, for example, a section including the electrophotographic photoreceptor may have a cartridge structure (process cartridge) that is attachable to and detachable from the image forming apparatus. The process cartridge may be, for example, a process cartridge including the electrophotographic photoreceptor according to the exemplary embodiment. The process cartridge may include, for example, at least one selected from the group consisting of a charging device, an electrostatic latent image-forming device, a developing device, and a transfer device, in addition to the electrophotographic photoreceptor.

An example of the image forming apparatus according to the exemplary embodiment will be described below, but the image forming apparatus is not limited to this example. The main parts shown in the figures will be described, and other parts will not be described.

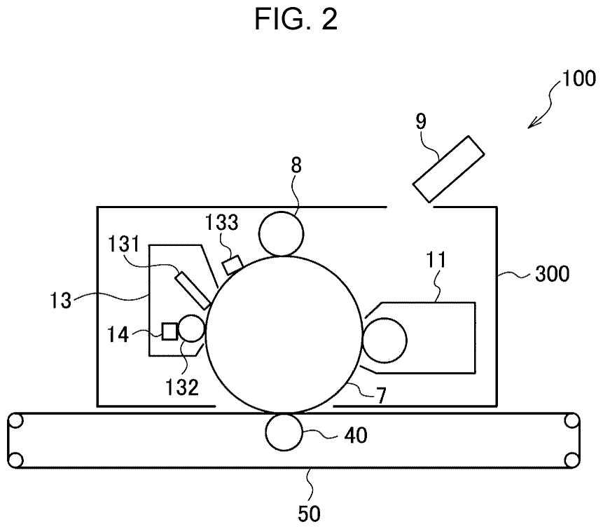

FIG. 2 is a schematic structural view of one example of the image forming apparatus according to the exemplary embodiment.

Referring to FIG. 2, an image forming apparatus 100 according to an exemplary embodiment includes a process cartridge 300 including an electrophotographic photoreceptor 7, an exposure device 9 (example electrostatic latent image-forming device), a transfer device 40 (first transfer device), and an intermediate transfer body 50. In the image forming apparatus 100, the exposure device 9 is positioned so as to expose the electrophotographic photoreceptor 7 to light from an opening of the process cartridge 300, the transfer device 40 is positioned so as to face the electrophotographic photoreceptor 7 with the intermediate transfer body 50 between the transfer device 40 and the electrophotographic photoreceptor 7, and the intermediate transfer body 50 is positioned such that part of the intermediate transfer body 50 is in contact with the electrophotographic photoreceptor 7. Although not shown, the image forming apparatus 100 further includes a second transfer device that transfers, to a recording medium (e.g., paper), a toner image that has been transferred to the intermediate transfer body 50. The intermediate transfer body 50, the transfer device 40 (first transfer device), and the second transfer device (not shown) correspond to examples of the transfer device.

The process cartridge 300 in FIG. 2 integrally supports, in a housing, the electrophotographic photoreceptor 7, a charging device 8 (example charging device), a developing device 11 (example developing device), and a cleaning device 13 (example cleaning device). The cleaning device 13 has a cleaning blade (example cleaning member) 131, and the cleaning blade 131 is disposed in contact with the surface of the electrophotographic photoreceptor 7. The cleaning member may be a conductive or insulating fibrous member, instead of the cleaning blade 131. The conductive or insulating fibrous member may be used singly or in combination with the cleaning blade 131.

FIG. 2 illustrates the image forming apparatus including a fibrous member 132 (roll shape) that supplies a lubricant 14 to the surface of the electrophotographic photoreceptor 7 and a fibrous member 133 (flat brush shape) that assists cleaning. These members are disposed as needed.

Each component of the image forming apparatus according to the exemplary embodiment will be described below.

### Charging Device

Examples of the charging device 8 include contact-type chargers using, for example, a conductive or semi-conductive charging roller, a charging brush, a charging film, a charging rubber blade, and a charging tube. Examples of the charging device 8 also include chargers known per se, such as contactless roller chargers, and scorotron chargers and corotron chargers using corona discharge.

### Exposure Device

Examples of the exposure device 9 include, for example, an optical device that exposes the surface of the electrophotographic photoreceptor 7 to light, such as semiconductor laser light, LED light, or liquid crystal shutter light, in a predetermined image pattern. The light source has a wavelength in the region of the spectral sensitivity of the electrophotographic photoreceptor. Semiconductor lasers that are mainly used are near-infrared lasers having an oscillation wavelength of about 780 nm. However, the wavelength is not limited to this, and a laser having an oscillation wavelength in the 600 nm range or a blue laser having an oscillation wavelength of 400 nm or more and 450 nm or less may also be used. A surface-emitting laser light source that may output multiple beams is also effectively used to form color images.

### Developing Device

The developing device 11 is, for example, a typical developing device that performs development using a developer in a contact or non-contact manner. The developing device 11 is not limited as long as the developing device 11 has the function described above, and the developing device 11 is selected according to the purpose. Examples of the developing device 11 include known developing units having a function of attaching a one-component developer or two-component developer to the electrophotographic photoreceptor 7 with a brush, a roller, or other tools. In particular, a developing device may use a developing roller that holds the developer on its surface.

The developer used in the developing device 11 may be a one-component developer containing only a toner, or may be a two-component developer containing a toner and a carrier. The developer may be magnetic or non-magnetic. The developer is known one.

### Cleaning Device

The cleaning device 13 is a cleaning blade-type device including the cleaning blade 131. The cleaning device 13 may be a fur brush cleaning-type device or simultaneous development cleaning-type device instead of a cleaning blade-type device.

### Transfer Device

Examples of the transfer device 40 include contact-type transfer chargers using a belt, a roller, a film, a rubber blade, or the like; and transfer chargers known per se, such as scorotron transfer chargers and corotron transfer chargers using corona discharge.

### Intermediate Transfer Body

The intermediate transfer body 50 may have a belt shape (intermediate transfer belt) containing polyimide, polyamideimide, polycarbonate, polyarylate, polyester, rubber, or the like provided with semiconductivity. The intermediate transfer body may have a drum shape instead of a belt shape.

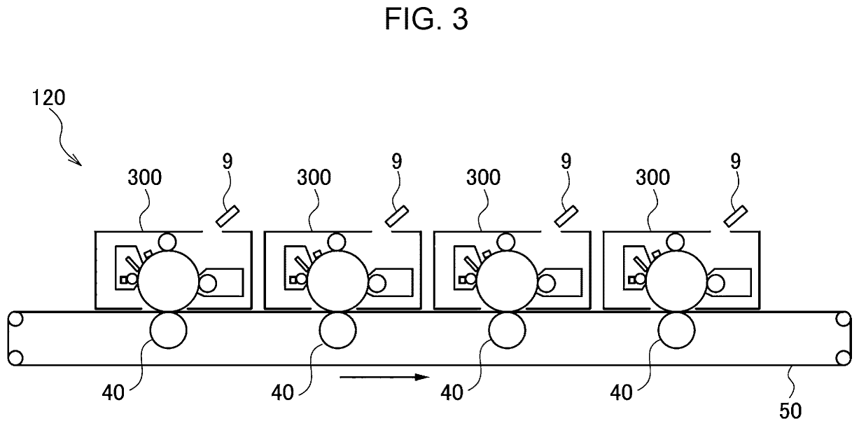

FIG. 3 is a schematic structural view of another example of the image forming apparatus according to the exemplary embodiment.

An image forming apparatus 120 in FIG. 3 is a tandem-system multicolor image forming apparatus including four process cartridges 300. In the image forming apparatus 120, the four process cartridges 300 are arranged in parallel on an intermediate transfer body 50, and one electrophotographic photoreceptor is used for one color. The image forming apparatus 120 has the same structure as the image forming apparatus 100 except for the tandem system.

### EXAMPLES

Exemplary embodiments of the present disclosure will be described below in detail by way of Examples, but exemplary embodiments of the present disclosure are not limited to these Examples.

In the following description, the units “part” and “%” are on a mass basis, unless otherwise specified.

In the following description, synthesis, production, treatment, measurement, and other processes are carried out at room temperature (25° C.±3° C.), unless otherwise specified.

### Production of Polyarylate Resin (1)

### Polyarylate Resin (1-1)

In a reaction vessel equipped with a stirrer, 12.6373 g of 4,4′-(2-ethylhexylidene)diphenol, 0.1233 g of 4-tert-butylphenol, 0.0632 g of sodium hydrosulfite, and 240 mL of water are placed to form a suspension. To the suspension, 4.8392 g of sodium hydroxide, 0.1981 g of benzyltributylammonium chloride, and 160 mL of water are added under stirring at a temperature of 20° C., and stirred in a nitrogen atmosphere for 30 minutes. To this aqueous solution, 220 mL of o-dichlorobenzene is added and stirred in a nitrogen atmosphere for 30 minutes, and 12.0000 g of 4,4′-biphenyldicarbonyl chloride is then added in the form of powder. After completion of addition, the resulting mixture is stirred at a temperature of 20° C. in a nitrogen atmosphere for four hours so that the reaction proceeds. The solution after polymerization is diluted with 300 mL of o-dichlorobenzene, and the aqueous phase is removed. After performing washing with dilute acetic acid solution and ion exchange water, the resultant is poured into methanol to precipitate a polymer. The precipitated polymer is separated by filtering and dried at 50° C. The polymer is re-dissolved in 900 mL of tetrahydrofuran and poured into methanol to precipitate a polymer. The precipitated polymer is separated by filtering, washed with methanol, and dried at 50° C. to obtain 17.5 g of a white polymer.

The molecular weight is determined by gel permeation chromatography (GPC) using tetrahydrofuran as an eluent, and the molecular weight of the polymer is calculated on a polystyrene basis. The weight average molecular weight of the polymer is 100,000.

The chemical structure of the polyarylate resin (1-1) is shown below.

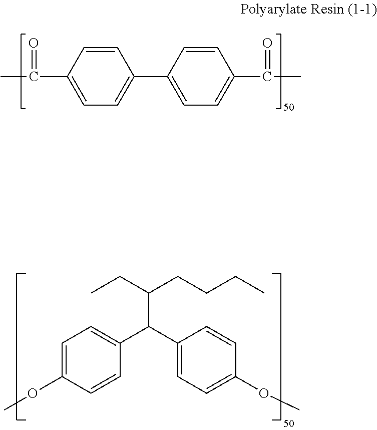

### Production of Photoreceptor

### Example 1

### Formation of Undercoat Layer

An aluminum cylindrical tube with an outer diameter of 30 mm, a length of 365 mm, and a wall thickness of 1 mm is prepared as a conductive substrate.

Zinc oxide (100 parts) (average particle size: 70 nm, specific surface area: 15 m²/g, available from TAYCA CORPORATION) is mixed with 500 parts of toluene under stirring, and 1.3 parts of a silane coupling agent (product name: KBM-603, available from Shin-Etsu Chemical Co., Ltd., N-2-(aminoethyl)-3-aminopropyltrimethoxysilane) is added and stirred for two hours. Subsequently, toluene is distilled off under reduced pressure, and baking is performed at 120° C. for three hours to obtain zinc oxide having a surface treated with the silane coupling agent.

The surface-treated zinc oxide (110 parts) is mixed with 500 parts of tetrahydrofuran under stirring, and a solution of 0.6 parts of alizarin in 50 parts of tetrahydrofuran is added. The resulting mixture is stirred at 50° C. for five hours. Subsequently, the solids of the mixture are separated by filtering under reduced pressure and dried at 60° C. under reduced pressure to obtain alizarin-added zinc oxide.

A solution is prepared by dissolving 60 parts of alizarin-added zinc oxide, 13.5 parts of a curing agent (blocked isocyanate, product name: Sumidur 3175, available from Sumika Bayer Urethane Co. Ltd.), and 15 parts of a butyral resin (product name: S-LEC BM-1, available from Sekisui Chemical Co., Ltd.) in 68 parts of methyl ethyl ketone, and 100 parts of the solution is mixed with 5 parts of methyl ethyl ketone. The resulting mixture is dispersed for two hours in a sand mill using glass beads having a diameter of 1 mm to obtain a dispersion. To the dispersion, 0.005 parts of dioctyltin dilaurate serving as a catalyst and 4 parts of silicone resin particles (product name: Tospearl 145, available from Momentive Performance Materials Japan LLC) are added to prepare a coating liquid for forming the undercoat layer. The coating liquid for forming the undercoat layer is applied to the outer circumferential surface of a conductive substrate by dip coating and cured by drying at 170° C. for 40 minutes to form the undercoat layer having an average thickness of 25 μm.

### Formation of Charge Generation Layer

A mixture composed of 15 parts of hydroxygallium phthalocyanine (having diffraction peaks at least at Bragg's angles (2θ±0.2°) of 7.5°, 9.9°, 12.5°, 16.3°, 18.6°, 25.1°, and 28.3° in an X-ray diffraction spectrum using CuKα characteristic X-rays) serving as a charge generating substance, 10 parts of a vinyl chloride/vinyl acetate copolymer resin (product name: VMCH, available from Nippon Unicar Company Limited) serving as a binder resin, and 200 parts of n-butyl acetate is dispersed for four hours in a sand mill using glass beads having a diameter of 1 mm. To the dispersion, 175 parts of n-butyl acetate and 180 parts of methyl ethyl ketone are added. The resulting mixture is stirred to obtain a coating liquid for forming the charge generation layer. The coating liquid for forming the charge generation layer is applied onto the undercoat layer by dip coating and dried at room temperature (25° C.±3° C.) to form a charge generation layer having an average thickness of 0.18 μm.

### Formation of Charge Transport Layer

The polyarylate resin (1-1) (30 parts) serving as a binder resin and 70 parts of CTM (1) serving as a charge-transporting material are dissolved in 135 parts of tetrahydrofuran and 15 parts of toluene to obtain a coating liquid for forming the charge transport layer. The coating liquid for forming the charge transport layer is applied onto the charge generation layer by dip coating and dried at 145° C. for 30 minutes to form a charge transport layer having an average thickness of 32 μm.

### Examples 2 to 26 and Comparative Examples 1 to 6

Photoreceptors are produced in the same manner as in Example 1 except that the outer diameter of the conductive substrate and the type and amount of charge-transporting material used to form the charge transport layer are changed to the specifications described in Table 4.

In Example 10, the polyarylate resin (1-1) is partially replaced by the polycarbonate resin (1-1) in formation of the charge transport layer to produce a photoreceptor. The chemical structure of the polycarbonate resin (1-1) is shown below. The numbers in the structural formula of the polycarbonate resin (1-1) express the molar ratio.

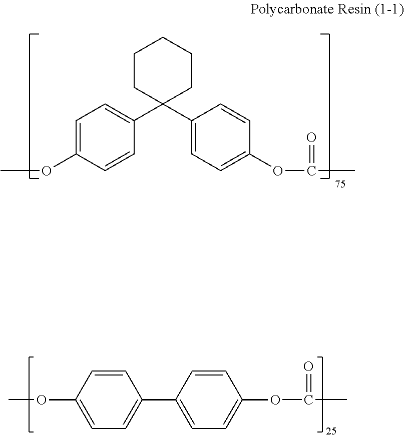

### Photoreceptor Performance Evaluation

### Wear Resistance

The photoreceptor is installed into an electrophotographic image forming apparatus (Apeos C7070, available from FUJIFILM Business Innovation Corporation), and a 100% solid image, a solid image with an image density (area coverage) of 100%, is formed on 100,000sheets of A3 paper in an environment with a temperature of 10° C. and a relative humidity of 15%. The average thickness of the charge transport layer is determined before and after this image formation, and a difference in average thickness between before and after the image formation is defined as a wear loss. FischerScope permascope is used as a coating thickness meter. The wear loss is classified as described below. Table 4 shows the results.
G0: The wear loss is less than 0.5 μm.
G0.5: The wear loss is 0.5 μm or more and less than 1 μm.
G1: The wear loss is 1 μm or more and less than 3 μm.
G2: The wear loss is 3 μm or more.

### Electrical Properties

The photoreceptor is installed into an electrophotographic image forming apparatus (Apeos C7070 modified machine, a modified machine with changed process speed), and a 100% solid image, a solid image with an image density (area coverage) of 100%, is formed on 1,000 sheets of A3 paper in an environment with a temperature of 10° C. and a relative humidity of 15%. This image formation is carried out at a process speed of 308 mm/sec and a process speed of 400 mm/sec.

The residual potential on the surface of the photoreceptor is measured after the first sheet is output and after 1,000 sheets are output, and a difference in the absolute value of the residual potential is obtained and defined as an increase in the absolute value of the residual potential. The increase in the absolute value is classified as described below. Table 4 shows the results.
G0: The increase in the absolute value of the residual potential is less than 10 V.
G0.5: The increase in the absolute value of the residual potential is 10 V or more and less than 30 V.
G1: The increase in the absolute value of the residual potential is 30 V or more and less than 50 V.
G2: The increase in the absolute value of the residual potential is 50 V or more.

In Table 4, “PS308” and “PS400” respectively mean a process speed of 308 mm/sec and a process speed of 400 mm/sec.

The chemical structures of the charge-transporting materials CTM (1) to CTM (5) are shown below.

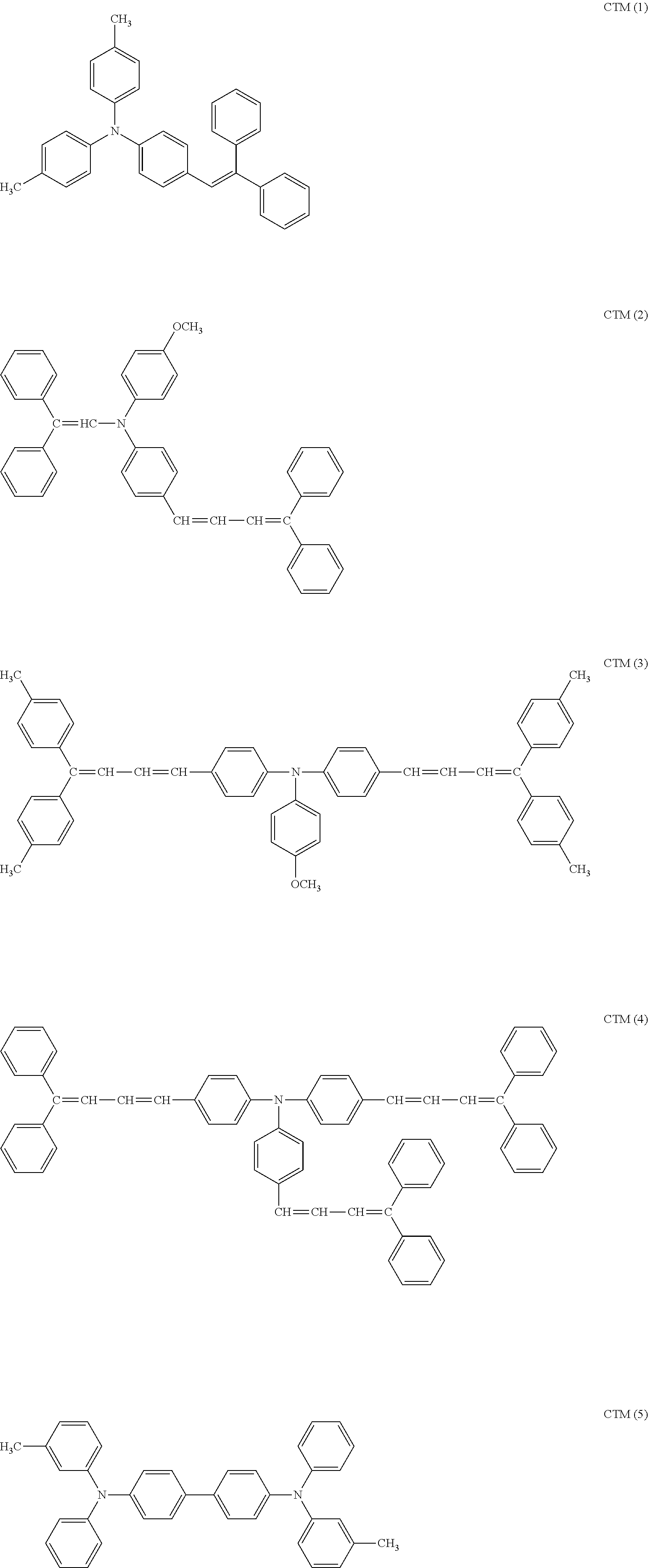

TABLE 4

| | | Charge Transport Layer | | | | | | |
|---|---|---|---|---|---|---|---|---|
| | | Binder Resin | | Charge | | | | |
| | Conductive | Polyarylate | Polycarbonate | Transporting | | Evaluation | | |
| | Substrate | Resin (1-1) | Resin (1-1) | Material | | Electrical Properties | | Wear |
| | Diameter | parts by | parts by | | parts by | PS308 | PS400 | Resistance |
| | mm | mass | mass | type | mass | residual potential | | wear loss |
| Comparative | 30 | 25 | 0 | CTM (1) | 75 | G0 | G0 | G1 |
| Example 1 | | | | | | | | |
| Example 1 | 30 | 30 | 0 | CTM (1) | 70 | G0 | G0 | G0.5 |
| Example 2 | 30 | 35 | 0 | CTM (1) | 65 | G0 | G0 | G0 |
| Example 3 | 30 | 40 | 0 | CTM (1) | 60 | G0 | G0 | G0 |
| Example 4 | 30 | 44 | 0 | CTM (1) | 56 | G0 | G0.5 | G0 |
| Comparative | 30 | 45 | 0 | CTM (1) | 55 | G1 | G1 | G0 |
| Example 2 | | | | | | | | |
| Example 5 | 30 | 35 | 0 | CTM (2) | 65 | G0 | G0 | G0 |
| Example 6 | 30 | 40 | 0 | CTM (2) | 60 | G0 | G0 | G0 |
| Example 7 | 30 | 40 | 0 | CTM (3) | 60 | G0 | G0 | G0 |
| Example 8 | 30 | 40 | 0 | CTM (4) | 60 | G0 | G0 | G0 |
| Example 9 | 30 | 40 | 0 | CTM (5) | 60 | G0.5 | G1 | G0 |
| Example 10 | 30 | 30 | 10 | CTM (1) | 60 | G0 | G0 | G0.5 |
| Comparative | 24 | 25 | 0 | CTM (1) | 75 | G0 | G0 | G2 |
| Example 3 | | | | | | | | |
| Example 11 | 24 | 30 | 0 | CTM (1) | 70 | G0 | G0 | G1 |
| Example 12 | 24 | 35 | 0 | CTM (1) | 65 | G0 | G0 | G0 |
| Example 13 | 24 | 40 | 0 | CTM (1) | 60 | G0 | G0 | G0 |
| Example 14 | 24 | 44 | 0 | CTM (1) | 56 | G0.5 | G0.5 | G0 |
| Comparative | 24 | 45 | 0 | CTM (1) | 55 | G1 | G2 | G0 |
| Example 4 | | | | | | | | |
| Example 15 | 24 | 40 | 0 | CTM (2) | 60 | G0 | G0 | G0 |
| Example 16 | 24 | 40 | 0 | CTM (3) | 60 | G0 | G0 | G0 |
| Example 17 | 24 | 40 | 0 | CTM (4) | 60 | G0 | G0 | G0 |
| Example 18 | 24 | 40 | 0 | CTM (5) | 60 | G0.5 | G1 | G0.5 |
| Comparative | 20 | 25 | 0 | CTM (1) | 75 | G0 | G0 | G2 |
| Example 5 | | | | | | | | |
| Example 19 | 20 | 30 | 0 | CTM (1) | 70 | G0.5 | G0 | G1 |
| Example 20 | 20 | 35 | 0 | CTM (1) | 65 | G0 | G0 | G0.5 |
| Example 21 | 20 | 40 | 0 | CTM (1) | 60 | G0 | G0 | G0 |
| Example 22 | 20 | 44 | 0 | CTM (1) | 56 | G0.5 | G1 | G0.5 |
| Comparative | 20 | 45 | 0 | CTM (1) | 55 | G1 | G2 | G0 |
| Example 6 | | | | | | | | |
| Example 23 | 20 | 40 | 0 | CTM (2) | 60 | G0 | G0 | G0 |
| Example 24 | 20 | 40 | 0 | CTM (3) | 60 | G0 | G0 | G0 |
| Example 25 | 20 | 40 | 0 | CTM (4) | 60 | G0 | G0 | G0 |
| Example 26 | 20 | 40 | 0 | CTM (5) | 60 | G0.5 | G1 | G0.5 |

The electrophotographic photoreceptor, the process cartridge, and the image forming apparatus according to the present disclosure include the following aspects. The formulas representing compounds are the same as the formulas with the same numbers described above.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An electrophotographic photoreceptor including:
a conductive substrate; and
a photosensitive layer that is disposed on the conductive substrate and has a charge generation layer and a charge transport layer,
wherein the charge transport layer contains a charge-transporting material and a polyarylate resin having a dicarboxylic acid unit represented by formula (A) and a diol unit represented by formula (B), and
a mass ratio of the charge-transporting material in the charge transport layer is 56 mass % or more and 70 mass % or less,

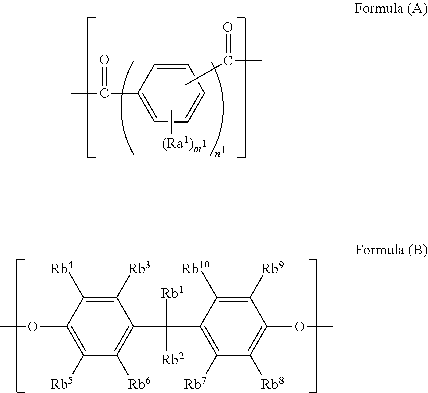

in formula (A), n¹ is 1, 2, or 3, n¹ m¹'s are each independently 0, 1, 2, 3, or 4, and m¹ Ra¹'s are each independently a C1-C10 alkyl group, a C6-C12 aryl group, or a C1-C6 alkoxy group, and
in formula (B), Rb¹ and Rb² are each independently a hydrogen atom, a C1-C20 alkyl group, a C6-C12 aryl group, or a C7-C20 aralkyl group, Rb³, Rb⁴, Rb⁵, Rb⁶, Rb⁷, Rb⁸, Rb⁹, and Rb¹⁰ are each independently a hydrogen atom, a C1-C10 alkyl group, a C6-C12 aryl group, a C7-C20 aralkyl group, or a C1-C6 alkoxy group, and Rb¹ and Rb² taken together optionally form a cyclic alkyl group.
   (((2))) The electrophotographic photoreceptor according to (((1))), wherein the mass ratio of the charge-transporting material in the charge transport layer is 60 mass % or more and 65 mass % or less.
   (((3))) The electrophotographic photoreceptor according to (((1))) or (((2))), wherein the charge-transporting material contains at least one selected from the group consisting of compounds represented by formula (1), compounds represented by formula (2), compounds represented by formula (3), and compounds represented by formula (4).

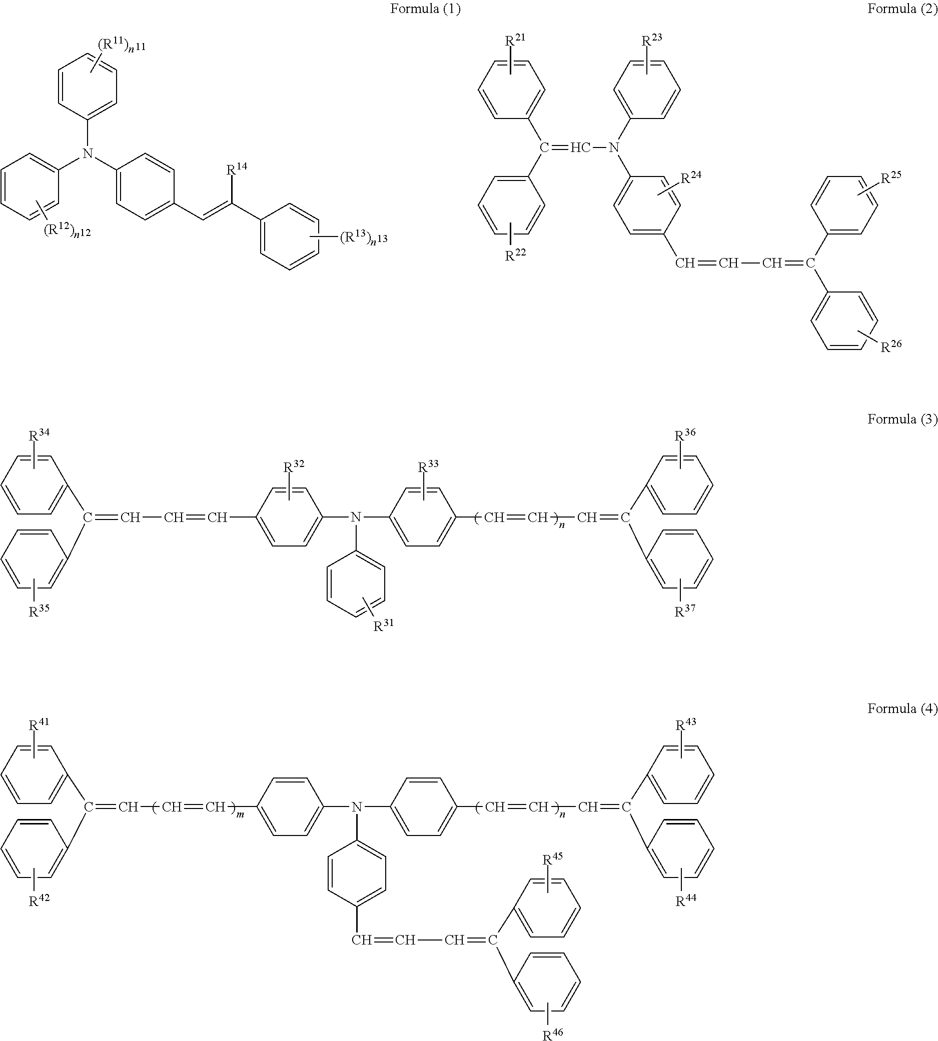

in formula (1), n¹¹ is an integer of 0 or more and 5 or less, n¹¹ R¹¹'s are each independently a C1-C6 alkyl group or a C1-C6 alkoxy group, and n¹² is an integer of 0 or more and 5 or less, and n¹² R¹²'s are each independently a C1-C6 alkyl group or a C1-C6 alkoxy group, n¹³ is an integer of 0 or more and 5 or less, and n¹³ R¹³'s are each independently a C1-C6 alkyl group or a C1-C6 alkoxy group, and R¹⁴ is a hydrogen atom, a C1-C8 alkyl group, a C1-C8 alkoxy group, or a phenyl group optionally substituted by a C1-C8 alkyl group,
in formula (2), R²¹, R²², R²³, R²⁴, R²⁵, and R²⁶ are each independently a hydrogen atom, a halogen atom, a C1-C20 alkyl group, a C1-C20 alkoxy group, or a substituted or unsubstituted C6-C30 aryl group, and adjacent substituents taken together optionally form a hydrocarbon ring structure,
in formula (3), R³¹, R³², R³³, R³⁴, R³⁵, R³⁶, and R³⁷ are each independently a hydrogen atom, a halogen atom, a C1-C20 alkyl group, a C1-C20 alkoxy group, or a substituted or unsubstituted C6-C30 aryl group, and n is 0 or 1, and
in formula (4), R⁴¹, R⁴², R⁴³, R⁴⁴, R⁴⁵, and R⁴⁶ are each independently a hydrogen atom, a halogen atom, a C1-C20 alkyl group, a C1-C20 alkoxy group, or a substituted or unsubstituted C6-C30 aryl group, m is 0 or 1, and n is 0 or 1.
   (((4))) The electrophotographic photoreceptor according to any one of (((1))) to (((3))), wherein the electrophotographic photoreceptor has a diameter of 25 mm or less.
   (((5))) A process cartridge including the electrophotographic photoreceptor according to any one of (((1))) to (((4))),
wherein the process cartridge is attachable to and detachable from an image forming apparatus.
   (((6))) An image forming apparatus including:
the electrophotographic photoreceptor according to any one of (((1))) to (((4)));
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

What is claimed is:

1. An electrophotographic photoreceptor comprising:
a conductive substrate; and
a photosensitive layer that is disposed on the conductive substrate and has a charge generation layer and a charge transport layer,
wherein the charge transport layer contains a charge-transporting material and a polyarylate resin having a dicarboxylic acid unit represented by formula (A) and a diol unit represented by formula (B), and
a mass ratio of the charge-transporting material in the charge transport layer is 56 mass % or more and 70 mass % or less, 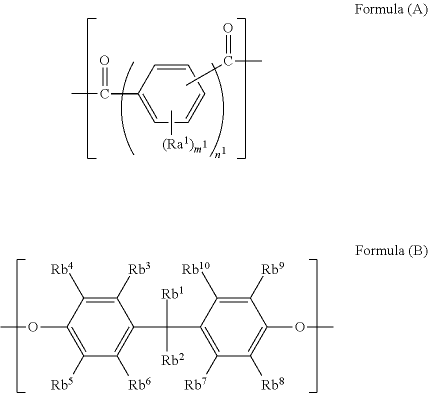
in formula (A), n¹ is 1, 2, or 3, n¹ m¹'s are each independently 0, 1, 2, 3, or 4, and m¹ Ra¹'s are each independently a C1-C10 alkyl group, a C6-C12 aryl group, or a C1-C6 alkoxy group, and
in formula (B), Rb¹ and Rb² are each independently a hydrogen atom, a C1-C20 alkyl group, a C6-C12 aryl group, or a C7-C20 aralkyl group, Rb³, Rb⁴, Rb⁵, Rb⁶, Rb⁷, Rb⁸, Rb⁹, and Rb¹⁰ are each independently a hydrogen atom, a C1-C10 alkyl group, a C6-C12 aryl group, a C7-C20 aralkyl group, or a C1-C6 alkoxy group, and Rb¹ and Rb² taken together optionally form a cyclic alkyl group.

2. The electrophotographic photoreceptor according to claim 1, wherein the mass ratio of the charge-transporting material in the charge transport layer is 60 mass % or more and 65 mass % or less.

3. The electrophotographic photoreceptor according to claim 1, wherein the charge-transporting material contains at least one selected from the group consisting of compounds represented by formula (1), compounds represented by formula (2), compounds represented by formula (3), and compounds represented by formula (4), 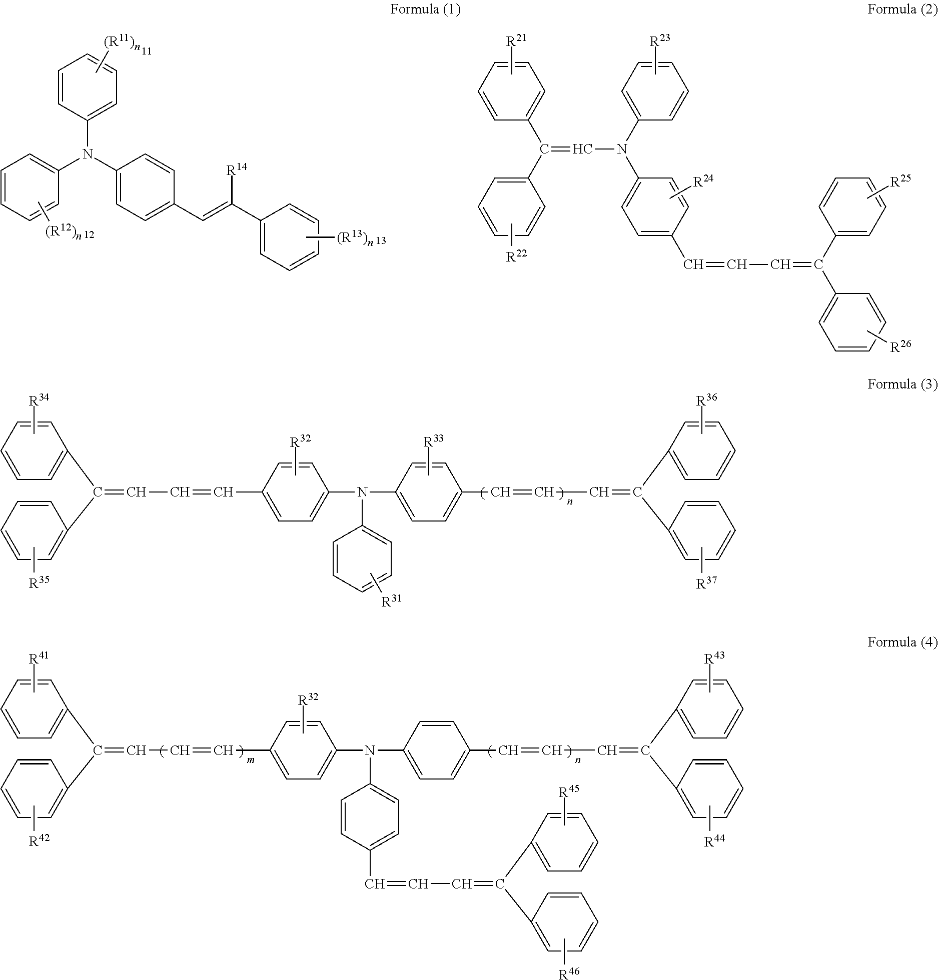
in formula (1), n¹¹ is an integer of 0 or more and 5 or less, n¹¹ R¹¹'s are each independently a C1-C6 alkyl group or a C1-C6 alkoxy group, and n¹² is an integer of 0 or more and 5 or less, and n¹² R¹²'s are each independently a C1-C6 alkyl group or a C1-C6 alkoxy group, n¹³ is an integer of 0 or more and 5 or less, and n¹³ R¹³'s are each independently a C1-C6 alkyl group or a C1-C6 alkoxy group, and R¹⁴ is a hydrogen atom, a C1-C8 alkyl group, a C1-C8 alkoxy group, or a phenyl group optionally substituted by a C1-C8 alkyl group,
in formula (2), R²¹, R²², R²³, R²⁴, R²⁵, and R²⁶ are each independently a hydrogen atom, a halogen atom, a C1-C20 alkyl group, a C1-C20 alkoxy group, or a substituted or unsubstituted C6-C30 aryl group, and adjacent substituents taken together optionally form a hydrocarbon ring structure,
in formula (3), R³¹, R³², R³³, R³⁴, R³⁵, R³⁶, and R³⁷ are each independently a hydrogen atom, a halogen atom, a C1-C20 alkyl group, a C1-C20 alkoxy group, or a substituted or unsubstituted C6-C30 aryl group, and n is 0 or 1, and
in formula (4), R⁴¹, R⁴², R⁴³, R⁴⁴, R⁴⁵, and R⁴⁶ are each independently a hydrogen atom, a halogen atom, a C1-C20 alkyl group, a C1-C20 alkoxy group, or a substituted or unsubstituted C6-C30 aryl group, m is 0 or 1, and n is 0 or 1.

4. The electrophotographic photoreceptor according to claim 1, wherein the electrophotographic photoreceptor has a diameter of 25 mm or less.

5. A process cartridge comprising the electrophotographic photoreceptor according to claim 1
wherein the process cartridge is attachable to and detachable from an image forming apparatus.

6. A process cartridge comprising the electrophotographic photoreceptor according to claim 2,
wherein the process cartridge is attachable to and detachable from an image forming apparatus.

7. A process cartridge comprising the electrophotographic photoreceptor according to claim 3,
wherein the process cartridge is attachable to and detachable from an image forming apparatus.

8. A process cartridge comprising the electrophotographic photoreceptor according to claim 4,
wherein the process cartridge is attachable to and detachable from an image forming apparatus.

9. An image forming apparatus comprising:
the electrophotographic photoreceptor according to claim 1;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

10. An image forming apparatus comprising:
the electrophotographic photoreceptor according to claim 2;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

11. An image forming apparatus comprising:
the electrophotographic photoreceptor according to claim 3;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

12. An image forming apparatus comprising:
the electrophotographic photoreceptor according to claim 4;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.
